(19) United States
(12) Patent Application Publication
(10) Pub. No.: US 2006/0230286 A1
(43) Pub. Date: Oct. 12, 2006

(54) System and method for authenticating a user of an image processing system

(76) Inventor: Hiroshi Kitada, Tuckahoe, NY (US)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/092,831

(22) Filed: Mar. 30, 2005

(51) Int. Cl. H04K 1/00; H04L 9/00

(52) U.S. Cl. 713/186; 713/183

(57) ABSTRACT

A method and system for multi-factor user authentication on an image processing device. The system includes a server used to authenticate a user, and to retrieve user information corresponding to user identification data. The user information is transmitted from the server to an image processing device, and processed by the image processing device. The processed image data can also be encrypted by using encryption information input to the image processing device.

### BACKGROUND OF THE INVENTION

1. Field of the Invention

The present invention is directed to methods and computer-based systems for authenticating a user of an image processing system.

2. Discussion of the Background

Over the past several years, there has been an increase in the number and types of document-related applications available over networks. These applications can include document management systems, such as those specializing in managing documents of various specific contents, for example medical, legal, financial, marketing, scientific, educational, etc. Other applications include various delivery systems, such as e-mail servers, facsimile servers, and/or regular mail delivery. Yet other applications include document processing systems, such as format conversion and optical character recognition systems. Further applications include document management systems used to store, organize, and manage various documents. These document management systems used to store, organize, and manage various documents may be referred to as “backend” applications.

Various systems for accessing these network applications from image processing devices (e.g., scanners, printers, copy machines, cameras) have been contemplated. One system associates a computer with each image processing device for managing the documents with the network applications. The computers communicate with the various network applications to enable the use of the applications by the user of the image processing devices. For example, the computers request and receive from the network applications information about the format and content of the data required by the applications to manage the documents. The computers process this information and configure the image processing devices to provide the correct format and content.

These systems authenticate a user at an image processing device using single-factor network user authentication. Single-factor user authentication typically involves entering only a username and password which are transmitted to a network server. The server then compares the submitted information to stored username and passwords which are authorized to access the system. Since all of the information needed to gain access to the network is actually stored on the network, single-factor authentication does not provide strong security against an unauthorized user. An authorized user's username or user ID is typically known, and therefore only the password needs to be compromised in order for an unauthorized user to gain access to the network. Also, storing password data on corporate networks introduces additional vulnerability to attackers who gain network access or may also facilitate insider fraud.

Current systems also fail to provide the ability for user-specific customization based on the entered authentication information. The information is entered to the network, and the user is authenticated, however, no user-specific customization is performed based on this user authentication.

### SUMMARY OF THE INVENTION

The present inventors have determined that there is a need for more secure and reliable user authentication for these image processing systems.

The present invention includes at least one image processing device, such as a multi-function device, but preferably several image processing devices, a document manager server connected to the image processing devices and network applications connected to the document manager server. The document manager server functions as an agent for the image processing devices and as a gateway to the network applications. The system also includes one or more devices for providing multi-factor user authentication on a network. These authentication devices, in the form of an electronic card reader and/or a biometrics detection, and/or other reader or detection device may be located within or near the image processing device.

In one embodiment, when the user of the system initiates the process of logging onto the system, a multiple-factor user authentication process is employed. Specifically, the user is required to provide or submit two or more pieces of information to facilitate authentication for a network. The user authentication information includes something a user physically has, such as a smartcard or a biometric, and something the user knows, such as a personal identification number (PIN) and a password. This information can be entered or detected via an electronic card reader or a biometric detection device located within or near the image processing device. Based on this initial multiple-factor authentication, information is retrieved corresponding to the user and is transmitted to the document manager server. The document manager server then transmits the information to a lightweight directory server, which processes the information and forms a judgment regarding the user's authorization to access the network.

In another embodiment of the present invention the image processing device settings, preferences and/or functionality may be altered upon successful authentication of a user for the network. Specifically, when a user is successfully authenticated, user-specific information is transmitted to a directory server which then processes the user-specific identification to authenticate a user. The directory server then accesses stored information corresponding to the received identification information to determine if any information is stored regarding specific user settings or preferences for the image processing device. If user-preference information is retrieved, it is subsequently transmitted to the image processing device via the document manager server. The image processing device then processes the user-preference information and changes scan settings, preferences, or other functionality based on this received information.

In another embodiment of the invention, processed image data is encrypted before the data is transmitted to a network application. If the processed image data is to be encrypted, the image processing device retrieves encryption information corresponding to the user from the electronic card or smartcard, or from another location. This encryption information is used to encrypt the image processed by the image processing device, before the image data is transmitted to a network application. Once the encrypted information is located in a network application, the user must then perform similar authentication steps to retrieve the encrypted image processing data from the network application. In one example, the document manager server deposits the encrypted image data to its destination via a secure/multipurpose mail extension (S/MIME). The user is then able to access the encrypted S/MIME e-mail from another location, for example from his or her personal computer. When the user attempts to access the encrypted e-mail, he/she is prompted for an electronic card. The user then swipes the smartcard and enters the PIN corresponding to the user. The user is then authenticated and granted access to both a decryption key and the network application.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram showing an overall system configuration according to one embodiment of the present invention;

FIG. 2 is a block diagram illustrating components of the image processing device and document manager server according to one embodiment of the present invention;

FIG. 3A shows an example of a scan to fax interface displayed on the image processing device according to one embodiment of the present invention;

FIG. 3B shows an example of a scan to backend system interface displayed on an image processing device according to one embodiment of the present invention;

FIG. 4A is a flowchart illustrating the steps by which a multi-function device obtains profile information according to one embodiment of the present invention;

FIG. 4B is a flowchart illustrating the steps performed by the multi-function device upon receipt of the profile information according to one embodiment of the present invention;

FIG. 5 is a flowchart illustrating steps performed in authenticating a user according to one embodiment of the present invention;

FIGS. 6A and 6B illustrate steps performed in authenticating a user using multi-factor authentication according to one embodiment of the present invention;

FIGS. 7A-7C illustrate a user authentication process for additional network applications after initial user authentication according to one embodiment of the present invention;

FIG. 8 shows exemplary code of a plug-in associated with a backend application according to one embodiment of the present invention.

FIGS. 9A-9B illustrate the steps performed when delivering a document to a backend system according to one embodiment of the present invention;

FIGS. 10A and 10B illustrate the steps performed in sending a facsimile according to one embodiment of the present invention;

FIG. 11 is a flowchart illustrating the steps performed when encrypting a processed image data according to one embodiment of the present invention;

FIG. 12 depicts a graphic representation a subset of hardware used for implementing one embodiment of the present invention;

FIG. 13 is a block diagram illustrating an image processing device according to one embodiment of the present invention;

FIG. 14 is a schematic representation of an image processing device according to one embodiment of the present invention;

FIG. 15 is a block diagram illustrating a server according to one embodiment of the present invention; and

FIG. 16 is a schematic representation of a server according to one embodiment of the present invention.

### DESCRIPTION OF THE PREFERRED EMBODIMENTS

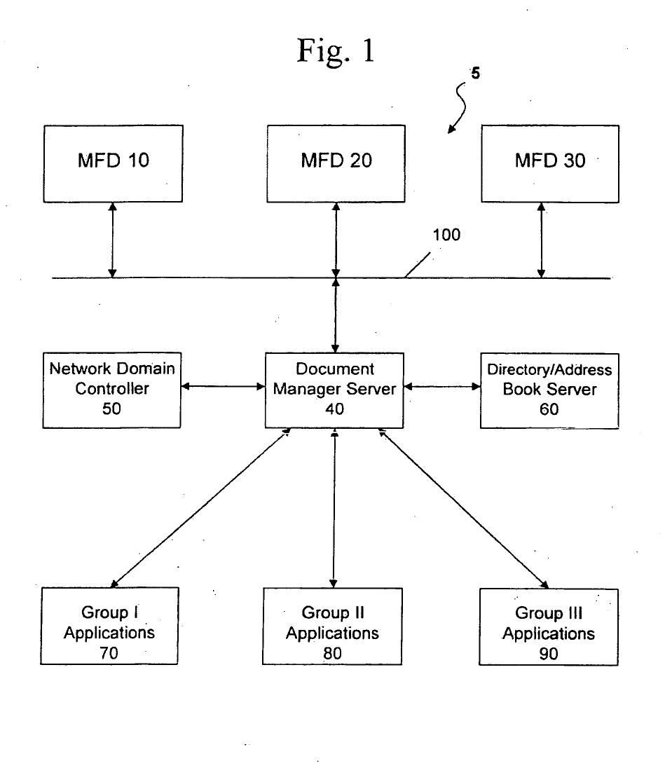

Referring now to the drawings, wherein like reference numerals designate identical or corresponding parts throughout the several views, FIG. 1 is a block diagram of a system 5 for managing documents according to the present invention, and in particular to allow a document manager server 40 to manage documents and files by processing information related to applications, which can be grouped in different groups I-III. The system 5 includes a network 100 that interconnects at least one, but preferably a plurality of image processing devices which may be implemented as multifunction devices (MFDs) 10-30, to a document manager server 40. The network 100 preferably uses TCP/IP (Transmission Control Protocol/Internet Protocol), but any other desirable network protocol such as, for example IPX/SPX (Internetwork Packet Exchange/Sequential Packet Exchange), NetBEUI (NetBIOS Extended User Interface), or NetBIOS (Network Basic Input/Output System) is possible. The network 100 can be a local area network, a wide area network, any type of network such as an intranet, an extranet, the Internet or a combination thereof. Other communications links for the network 100, such as a virtual private network, or a wireless link, or any other suitable substitute may be used as well.

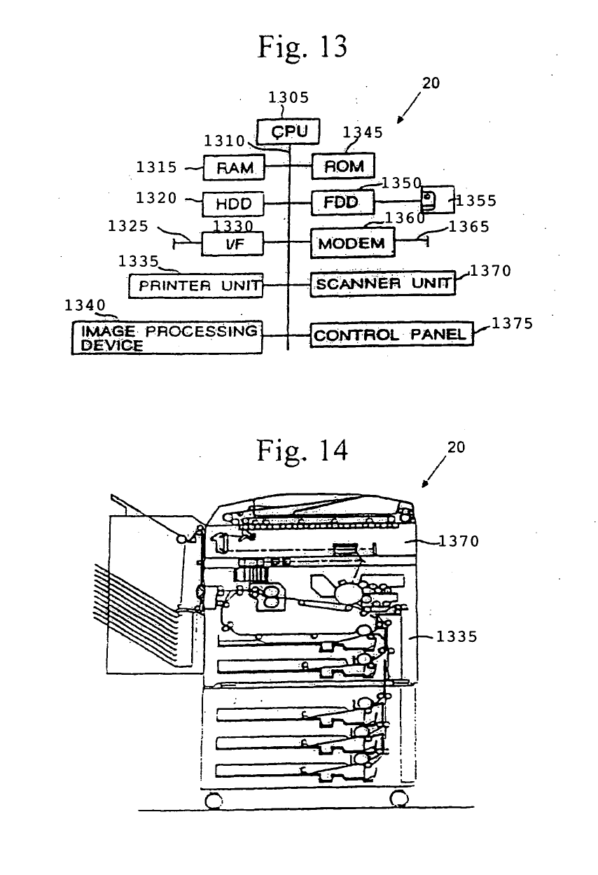

As shown in FIG. 1, the devices 10-30 can be multi-function devices, or “MFDs.” An MFD may incorporate or be any one of a plurality of a scanner, a copy machine, a printer, a fax machine, a digital camera, other office devices, and combinations thereof. Any one or combinations of these devices are referred to as a MFD, generally. Various types of MFDs are commonly known in the art and share common features and hardware with the MFDs of the present invention. In one embodiment of the present invention, the MFD is a portable device, such as a digital camera, connectable to the Internet via a wired or wireless connection. Such an MFD combines digital imaging and internet capabilities so that one can capture still images, sounds or videos and share such multimedia using wired or wireless connections from various locations. The MFD can create web pages, send and receive e-mails with attachments, edit images, FTP files, surf the Internet, and send or receive a fax. In another embodiment, the MFD is one of a combination of a scanner, photocopier and printer, as described in more detail below with corresponding FIGS. 13-14.

The MFD is also connected to a user authentication device configured to accept information from an electronic card or memory, and/or a biometric device configured to sense biometric information input by a user. These user authentication devices may be located within or near the image processing device, and are in communication with the image processing device. The image processing device and user authentication devices may be connected by any type of wired or wireless connection for facilitating the transfer of information between the devices. It should be noted that while the term “smartcard” is used throughout the application, this term refers to any type of card or memory device for storing user information and capable of being read by an electronic device. Also, the card and the device used to read the card may be a scan sensor used to read directly from the card, or alternatively a proximity sensor configured to read data from the device without physically making contact with the card.

As shown in FIG. 1, the document manager server 40 is connected to a directory/address book server 60 (or “directory server” or “global directory”). The directory server 60 can include information such as the names, addresses, network addresses, e-mail addresses, phone/fax numbers, other types of destination information, and authorization of individuals. Other information can also be included in the directory server 60. Examples of directory servers 60 compatible with the present invention include, but are not limited to, Lotus Notes™, Microsoft Exchange™, and LDAP (“Lightweight Directory Access Protocol”) enabled directory servers. LDAP is a software protocol that enables a user to perform network authentication, locate organizations, individuals, files, devices in a network. The document manager server 40 can also be connected to a network domain controller 50 that controls authentication of the MFD user. The directory server is configured to receive user information entered at the authentication device or image processing device and authenticate the user for the network.

The network domain controller 50 is, for example, a server that responds to security authentication requests, such as logging in, within its domain. The network domain controller 50 may be backed up by one or more backup network domain controllers that can optionally also handle security authentication. Examples of a directory server 60 and a network domain controller 50 are disclosed in U.S. application Ser. No. 10/243,645, filed Sep. 16, 2002, the entire content of which is hereby incorporated by reference.

Briefly, the system 5 provides access for the users of the MFDs 10-30 to the information stored at the directory server 60 via the document manager server 40. The system 5 also allows for users, who are authenticated at the image processing device, to transmit a digital signature to the directory server 60. The digital signature is retrieved from the authentication information device and other user-specific identification information, such as encryption information, etc., may be transmitted instead of the digital signature.

The directory server 60 is then capable of retrieving preference information related to the digital signature and transmits this preference information to the MFDs 10-30. This preference information may include information relating to scan settings, such as resolution, density, scan mode, color, paper size, file format, or any additional settings that can be adjusted at the MFD. The preference information may also include information relating to the network application which is the destination of the processed image, including a specific e-mail address, a backend system, a middle processing system, or any other network application configured to accept the processed data. A middle processing system may include a file formation conversion system, optical character recognition, or any similarly suited system as will be described in greater detail below. Also, the preference information may include a software plug-in, which will be discussed in greater detail below, or any other information related to changing the functionality of the MFD. After receiving this information, the MFD processes the preference information and makes changes corresponding to the preference data before the user processes an image.

A user can also request a search of the company's global directory stored at the directory server 60. The document manager server 40 can pass the search request to the directory server 60 and can receive the search results (e.g., e-mail addresses and/or fax numbers) from the directory server 60. The document manager server 40 can pass the search results to the MFD 20, which can temporarily store and display them. The user can select a displayed result (e.g., an e-mail addresses or a fax number), scan a document, and request that the scanned document be transmitted, e-mailed and/or faxed to the selected destination.

The document manager server 40 can be configured to act as an intermediate agent, or a gateway between a plurality of network applications 50, 60, 70, 80, and 90 and the MFDs. The applications 70, 80, and 90 can include for example an e-mail server, a fax server, a file format conversion system, an optical character recognition (OCR) system, a document management system and a file storage system or any combination of multiples thereof. The document management server 40 is capable of supporting a plurality of backend systems such as various document management systems, or file storage systems. In a preferred embodiment, the e-mail server is incorporated into the document manager server 40. The e-mail server can include, but is not limited to, Lotus Notes™ e-mail server, Microsoft Exchange™ e-mail server, and SMTP (“Simple Mail Transfer Protocol”) e-mail servers. In a preferred embodiment, the fax server is the Captaris' RightFax™ server. However, other suitable fax servers may be implemented in accordance with the present invention. The file format conversion system can be configured to convert a document from one format (e.g., TIFF, “Tag Image File Format”) to another (e.g., PDF, “Portable Document Format”). An example of a document management system is disclosed in U.S. application Ser. No. 09/795,438, filed Mar. 1, 2001; and in U.S. application Ser. No. 10/116,162, filed Apr. 5, 2002, the entire contents of which are hereby incorporated by reference. Other document management systems include systems that specialize in managing documents having a specific content. As an example, the document management systems could be the system implemented by the Centers for Medicare & Medicaid Services for managing medical and insurance records as provided under the Health Insurance Portability and Accountability Act (HIPAA). Documentum is an exemplary brand of a digital file management system used to manage, store and perform other various file management operations on stored document/record/multimedia files. Other systems for managing and/or storing documents, such as legal, financial, marketing, scientific, educational, can be connected to the document manager server 40.

As stated above, the document management server 40 is capable of supporting a plurality of such systems simultaneously. As will be described later, a profile can be configured to support multiple systems via software plug-ins and the image processing devices 10, 20, 30 capabilities and user interface can be customized based on the plug-ins.

These applications can be grouped, for example in Groups I-III. Group I can be a delivery system group including an e-mail server and a fax server; Group II can be a middle processing group including a file format conversion system and an optical character recognition system; and Group III can be a backend system group including a document management system and a file storage system. Groups I-III can include a plurality of devices from each category. For example, the document management server 40 can be connected to a plurality of applications from each group. The document manager server 40 can direct documents to several applications within each group. In a preferred embodiment, the document manager server 40 delivers a document to several of the applications within the delivery system group, but delivers the document to one or a plurality of the application within the middle processing group and to one or a plurality of the applications of the backend system group. For example, the document manager server 40 can deliver a document to the e-mail and fax servers, to the OCR system, and to a document management system. Other combinations are possible in other embodiments.

In a preferred embodiment, the MFDs 10-30 and the document manager server 40 exchange data using the protocol HTTP (“Hypertext Transfer Protocol”) or HTTPS (HTTP over Secure Socket Layer) over the network 100. Other protocols such as TCP/IP, IPX/SPX, NetBEUI, or NetBIOS, for example can equivalently be used with the present invention. Preferably, the MFDs 10-30 and the document manager server 40 exchange data using the format XML (“Extensible Markup Language”). Other formats, such as HTML, can equivalently be used with the present invention.

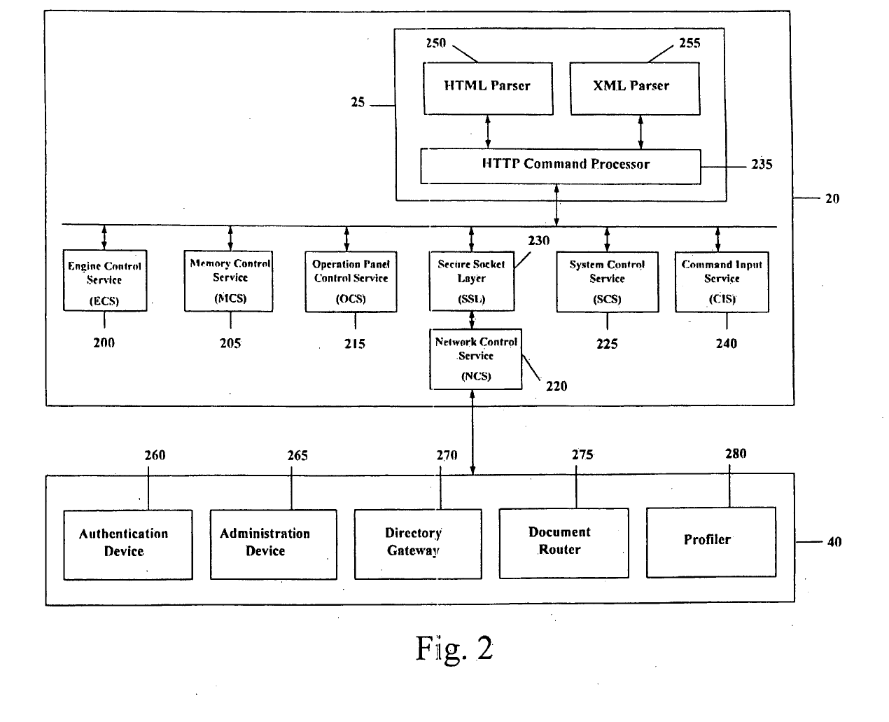

In one embodiment, the document manager server 40 can include an MFD profiler 280 (shown in FIG. 2) that manages profiles for the MFDs 10-30. The administrator of the system 5 can create, change and maintain the profiles via a profile user interface on the document manager server 40. A profile includes information (e.g., parameters) sent from the document manager server 40 to an MFD. Based on this information, the MFD can adjust its user interface and functions so as to properly interface with the document manager server 40. The information may also include software plug-ins processed by the MFD to allow the operation of the MFD to be modified based on the existence or introduction of a backend system. The document manager server 40 includes software plug-ins corresponding to the backend applications connected to the document manager server 40. For example, the MFD can display selections allowing a user to select options (e.g., a particular delivery system, a middle processing system, or a backend system) available to the MFD via the document manager server 40. Information included in the profile can be the identity of the various applications 70-90 connected to the document manager server 40. The profiler 280 receives identification information from an MFD (e.g., the serial number) and uses this identification information to check whether the MFD is registered within a register, e.g., a data table stored in a memory of the document manager server 40. If registered, the profiler sends the MFD a profile assigned to the MFD. If the MFD is not registered, the profiler can register the MFD and send the MFD a profile. The profiler can store more than one profile. In a preferred embodiment, one profile is assigned to each MFD, and more than one MFD can share the same profile. While the term “software plug-in” has been used, any type of software, programming, or chip can be used to modify the operation of the MFD.

Examples of parameters in a profile include, but are not limited to:
a profile ID, which identifies the profile;
an LDAP Enabled parameter, which indicates whether or not the LDAP tree search is enabled on the document manager server 40 using the directory server 60;
a Base Domain Name (DN) parameter, which provides a default field of search for the LDAP tree when the LDAP search is enabled;
a Network Authentication parameter, which indicates whether or not network authentication is enabled using the network domain controller 40;
a Time-Out parameter, which indicates the time period that should elapse before the MFD resets and requires the user to enter login information;
a Max Result Count parameter, which determines the maximum number of LDAP query results returned;
a Fax Option parameter, which indicates whether or not a fax server is connected to the document manager server 40;
a Post Scan Processing parameter, which indicates what post scan processing system is connected to the document manager server 40, post scan processing systems may include, for example an e-mail server, a file format conversion system, an optical character recognition system, etc.;
a Backend parameter, indicating which backend systems are connected to the document manager server 40 and are able to be accessed by the MFD, such backend systems may include, a document management system or a file storage system, or another similar type of system; and

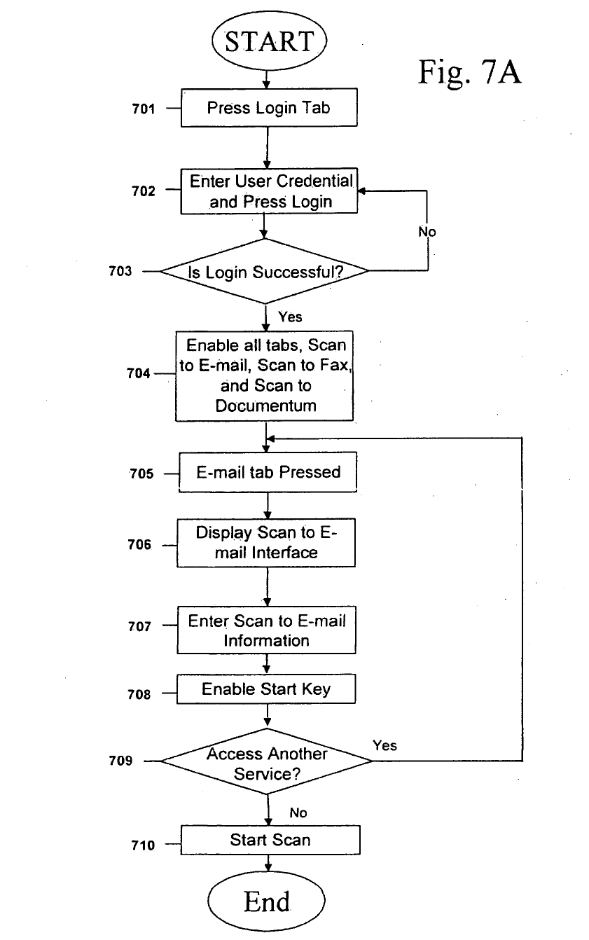

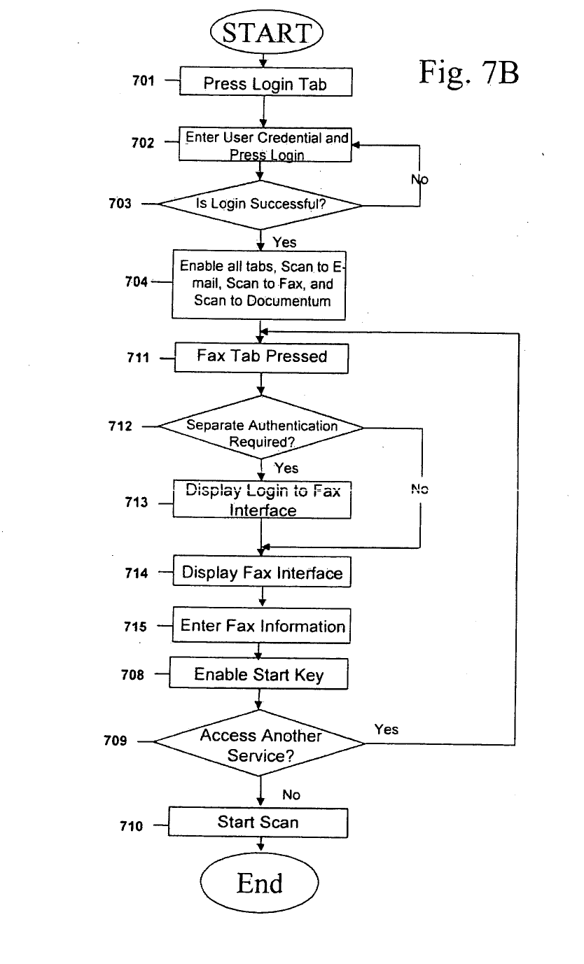

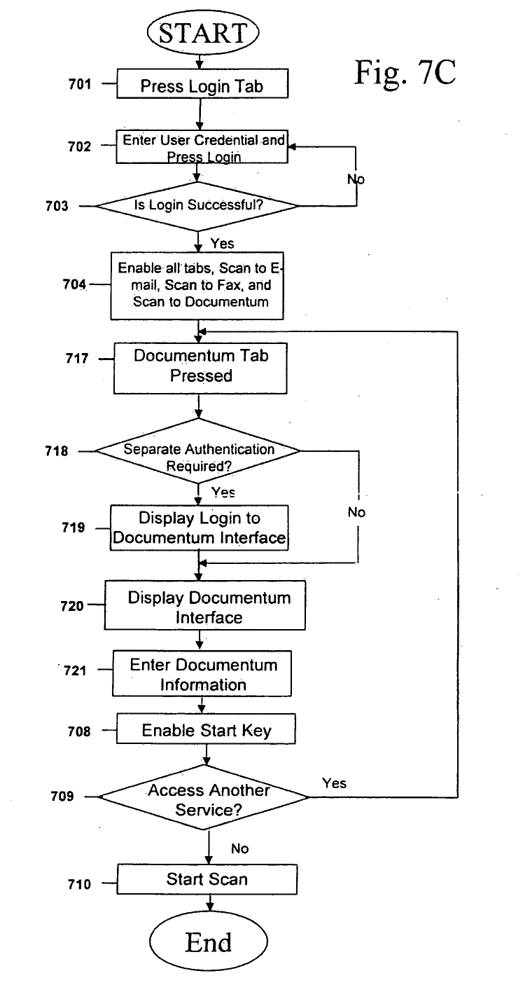

a Software Plug-in, exemplary code for which is depicted in FIGS. 7A-7C, which contains and executable file allowing the image processing device to perform
specific processing tasks related to a backend application.

Other parameters can also be included in the profile. For example, parameters reflecting specific user ID, default size of papers, scanning resolution setting, condition of the document feeder, department code for billing image processing operations, additional scanning job parameters for the specific user ID, or any additional parameters may be used.

The Backend parameter might also indicate if a user is required to log-in to the backend system after the user has already logged into the network. Further, the Backend parameter could also initiate an authentication step to determine if a user has already logged into the network and been automatically authenticated to operate the back-end system based on the network authentication. If the Backend parameter indicates that a software plug-in is required for the MFD device to properly interface with the backend application, then the MFD transmits data to the document manager server 40 requesting the receipt of a software plug-in.

FIG. 2 illustrates an MFD 20's browser 25 configured to exchange information between the MFD 20 and the document manager server 40 according to one embodiment of the present invention. An example of a browser 25 is disclosed in U.S. application Ser. No. 10/243,643, filed Sep. 16, 2002, the entire content of which is incorporated by reference. Further details of the browser 25 are set forth below. FIG. 2 shows the software components of the document manager server 40, which includes an authentication device 260 configured to perform the authentication functions discussed above. The document manager server 40 also includes an administration device 265 which allows the system administrator to administer the system 5. For example, the administrator of the system can access the profiler 280 via the administration device 265 to set user profiles and/or the MFD profiles for the MFDs 10-30 connected to the document manager server 40. A directory gateway 270 is also included within the document manager server 40 and is configured to communicate with the directory server 60. The document manager server 40 also includes a document router 275 configured to route the documents received from the MFDs to the appropriate applications 70, 80 and 90.

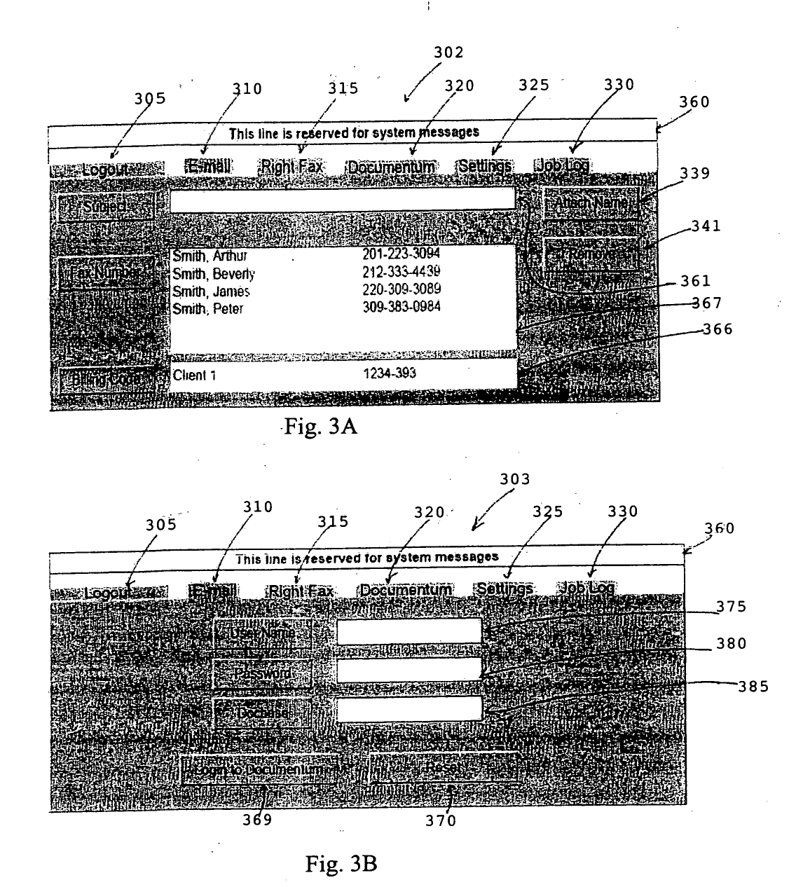

As shown in FIG. 2, the MFD 20 includes an engine control service (ECS) 200 that controls, for example, the scanning engine of the MFD 20. A memory control service (MCS) 205 controls access to the memory of the MFD 20. An operation panel control service (OCS) 215 generates outputs which are displayed on the touch-panel type liquid crystal display (LCD) of the MFD 20. It should be noted that the display and user interface of the MFD 20 is not limited to an LCD display, but may also be any other suitable device, or combination of devices, such as but not limited to LCDs, light-emitting diode (LED) displays, cathode ray tube (CRT) displays, plasma displays, keypads, and/or keyboards. The OCS 215 can generate, for example, conventional menus for MFD operation and the menu shown in FIG. 3A-3B. A system control service (SCS) 225 controls and/or monitors sensors within the MFD 20. For example, the SCS 225 controls the touch screen sensors, paper jam sensors and scanning operation sensors. Accordingly, the SCS 225 can manage the status of the MFD 20 based on the information from the sensors. A network control service (NCS) 220 controls communication between the browser 25 and the document manager server 40. Optionally, a secure socket layer (SSL) 230, in the form of a communication formatting device or routine, provides added security for communications between the NCS 220 and the browser 25. A command input service (CIS) 240 processes input information, for example, from the LCD touch panel and/or a keypad of the MFD 20. A user of the MFD can enter information and commands using the LCD touch panel and the keypad. The CIS 240 can process such information and commands entered by a user (e.g., forwarded to the CIS 240 by the SCS 225). The CIS 240 can generate a command (e.g., a display command) based on such processing and transmit the command to other components of the MFD (e.g., to the OCS 215 to display a graphic on the LCD). The CIS 240 can also exchange information and commands with the NCS 220 for processing with the browser 25 in connection with the server 40.

Conventional MFDs include ECSs, MCSs, OCSs, NCSs, SCSs, and CISs which are firmware for implementing and controlling each hardware component of the MFD. In the present invention, however, the NCS 220 is configured to communicate with the browser 25. For instance, the NCS 220 has additional capabilities for communicating using the HTTP protocol. The NCS 220 is also configured to communicate with the server 40 so that the NCS 220 exchanges data between the browser 25 and the server 40. For example, The NCS 220 can transmit to the server 40 an identification and receive a profile, can transmit a request for an e-mail address and can receive from the server 40 a selected e-mail address, or the NCS 220 can transmit to the server 40 login information and can receive a user authentication confirmation from the server 40 (and from the directory server 60) during an authentication process. The NCS 220 is also capable of receiving plug-in information from the document manager server 40 which is capable of initiating the authentication procedure described above or altering the user interface described in FIGS. 3A-3B.

The browser 25 includes an HTTP command processor 235 that communicates with the network control service (NCS) 220 of the MFD 20. For example, a request for an e-mail address entered by the user via the MFD keypad, or a request for displaying information on the LCD, such as FIG. 3A-3B, can be passed from the NCS 220 to the browser 25 by the HTTP command processor 235. The HTTP command processor 235 can exchange data in the HTML format with the browser's HTML parser 250, and can exchange data in the XML format with the XML parser 255. The parsers 250 and 255 can check the data from the HTTP command processor 235 for syntax and process the data for HTTP command processor 235. The present invention can include conventional parsers, which are conventionally included as part of a compiler.

The HTTP command processor 235 can be provided with a program code, or software plug-in, for implementing a specific application, such as user authentication processing which can be implemented with the directory service of the server 40. The HTTP command processor 235 can process information based on definitions of the specific application. For example, the HTTP command processor 235 can process information provided by the user, such as User Name or Password, and generate an HTTP request based on this processing for the server 40. The HTTP command processor 235 can transmit this HTTP request to the NCS 220 to be transmitted to the server 40. The HTTP command processor 235 can also receive plug-in information relating to specific backend system functionalities. These plug-ins allow for users to add processing instructions, metadata, and other indexing information to the image file transmitted to the document manager server 40.

The HTTP command processor 235 can also process information received from the server 40 (via the NCS 220). For example, the HTTP command processor 235 can receive an HTTP response generated by the server 40 which includes a profile with parameters or software plug-ins for operating the MFD. The HTTP command processor 235 can process this information and generate commands to control the MFD in accordance with the information, e.g., can request the MFD to display a menu with the appropriate buttons, or to scan according to the scanning job parameters for the specific user ID. As another example, the HTTP command processor 235 can generate a graphic drawing command for the LCD panel. The HTTP command processor 235 can transmit the commands to the appropriate MFD firmware (e.g., the OCS 215) to be executed. For example, the OCS 215 can receive the graphic drawing command and execute it by displaying a graphic (e.g., FIG. 3A-3B) on the LCD panel.

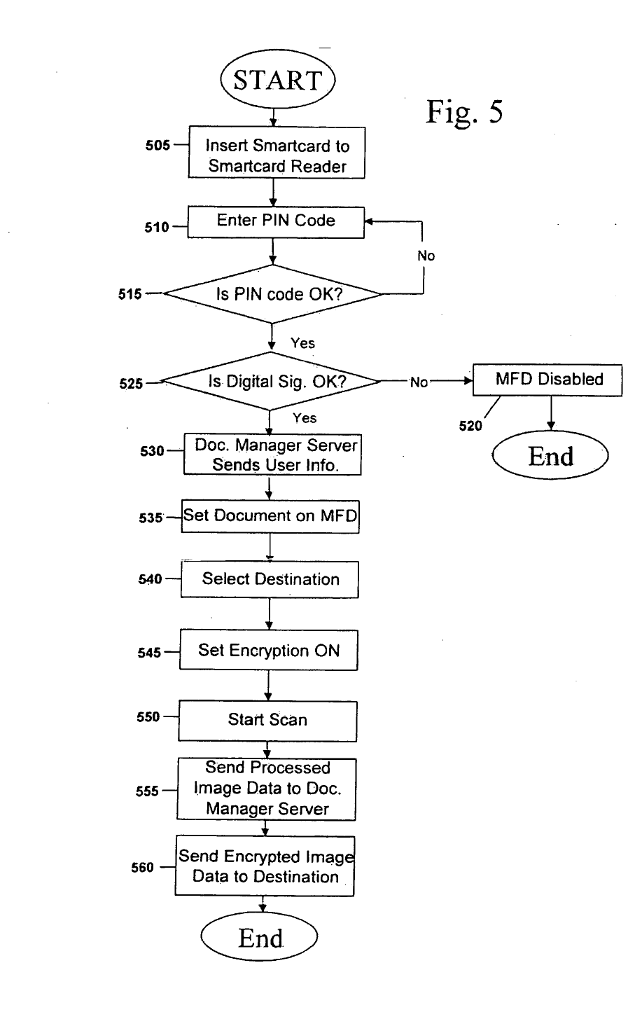

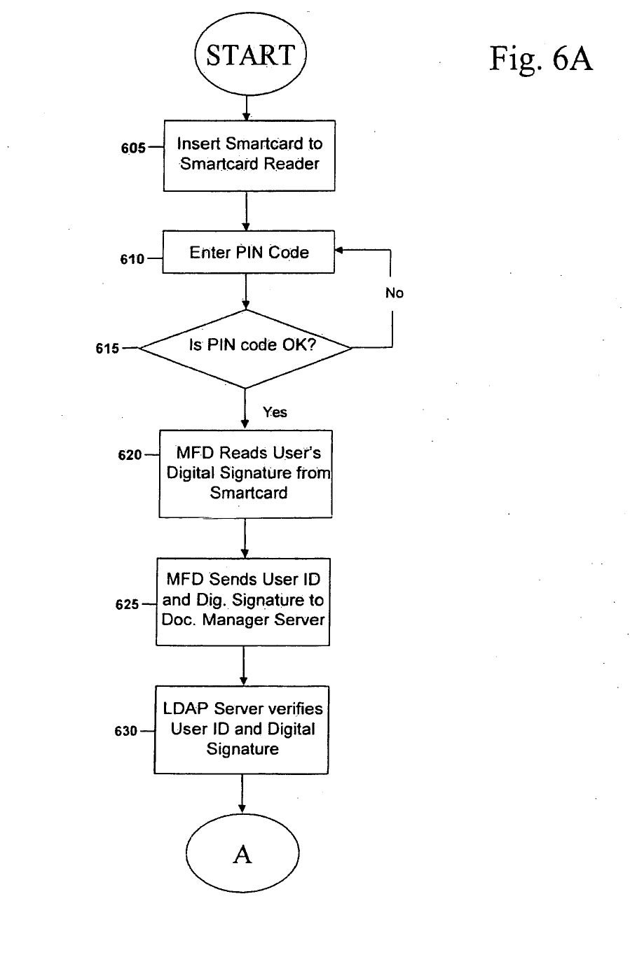

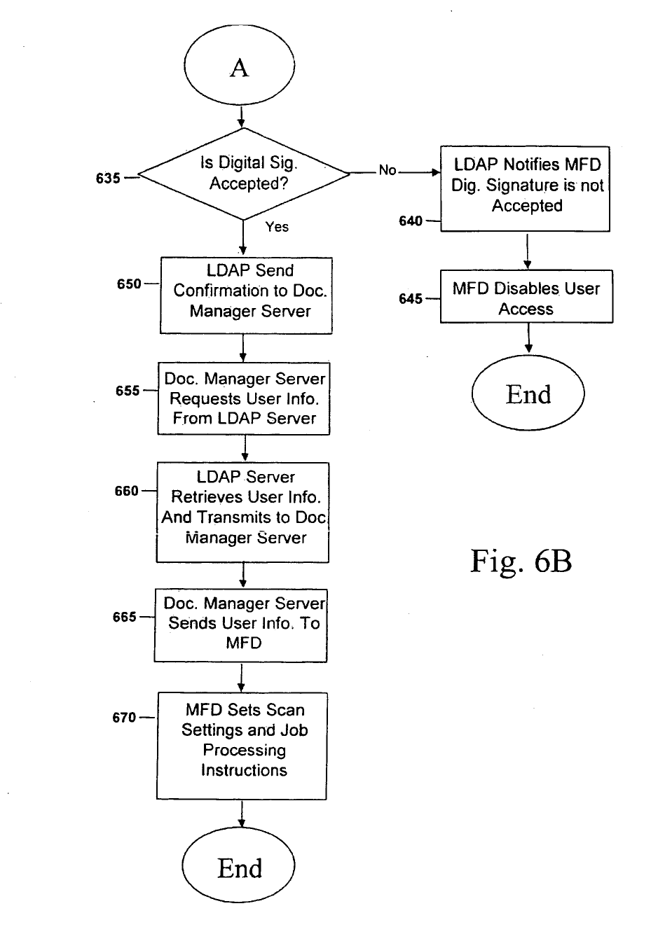

FIGS. 3A-3B show exemplary representations of user interfaces displayed on the user interface of the MFD. It should be noted that the authentication steps described below in relation to these figures relate to a second user authentication only. This second user authentication occurs only when the user has already logged into the system using the multi-factor authentication which will be described below while referring to FIGS. 5 and 6A-6B.

FIG. 3A-3B illustrate examples of user interfaces 302-303 for providing instructions to the user and touch sensitive buttons, for example, buttons 305-330, for providing user input to the system shown in FIG. 1. As described above, the user interface 302-303 is preferably an LCD touch panel, although any combination of displays and input devices can be used, such as but not limited to LCDs, LEDs, CRTs, plasma displays, keypads, and/or keyboards.

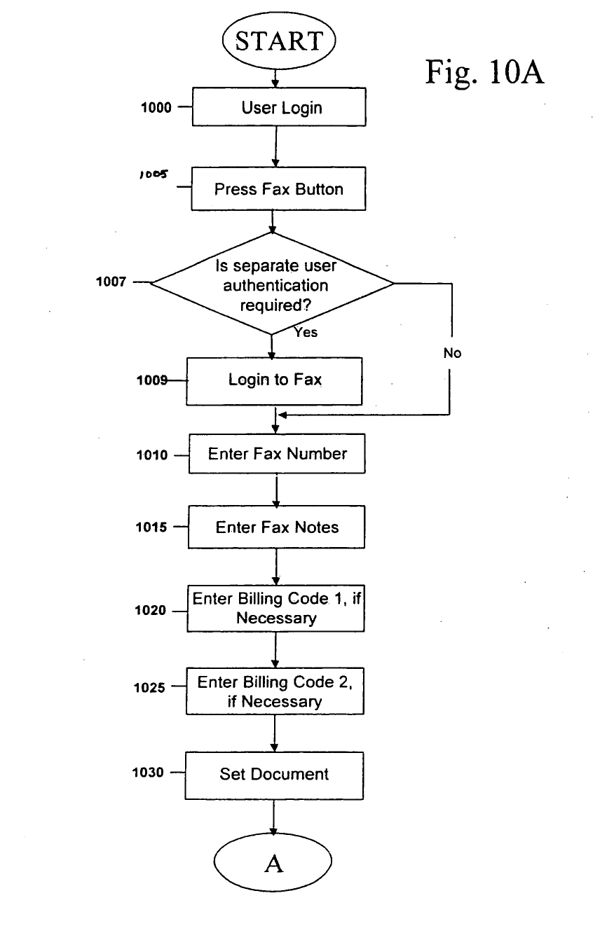

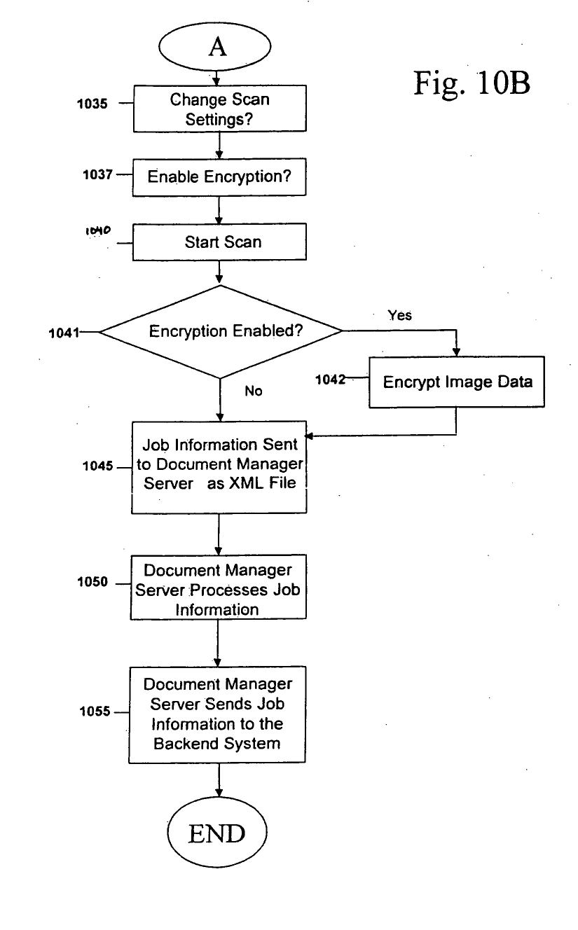

FIG. 3A illustrates a user interface 302 displayed when the user selects the “Right Fax” tab 315. Right Fax is described as an exemplary embodiment of facsimile processing server, however any other suitable facsimile processing server may be similarly implemented. The facsimile user interface 302 includes a “Subject” text area 361, for inputting the subject of a transmitted facsimile, and “Fax Number” 367 and “Billing Code” 366 information fields. The “Billing Code” field can be used to enter a billing code associated with a job being processed and may be stored in a database to properly track billing information of faxed jobs. “Attach Name” 339 and “Remove” 341 buttons are also provided allowing the user to attach a name or telephone number and remove the number respectively. The process of sending transmitting a facsimile will be described in greater detail below in reference to FIGS. 10A-10B.

FIG. 3B illustrates the user interface 303 displayed when the user selects the “Documentum” tab 320. Documentum is an exemplary brand of a digital file management system used to manage, store and perform other various file management operations on stored document/record/multimedia files. If the Documentum system is located on a network for which the user is not yet authenticated when the user selects the “Documentum” tab 320, a user interface is displayed prompting the user to login to the “Documentum” system network. The user interface 303 includes prompts for a “User Name” 375, “Password” 380, and “Docbase” 385. The system also includes the buttons “Login to Documentum” 369 and “Reset” 370. The “Login to Documentum” button initiates the transmission of the user's login information to the Documentum system allowing the user to be authenticated and gain access to the Documentum system. Once the user gains access to the Documentum system documents can be stored to specific locations, documents can be retrieved to be printed, and retrieved documents can be e-mailed to specified recipients. Other functions can also be performed based on the backend application selected.

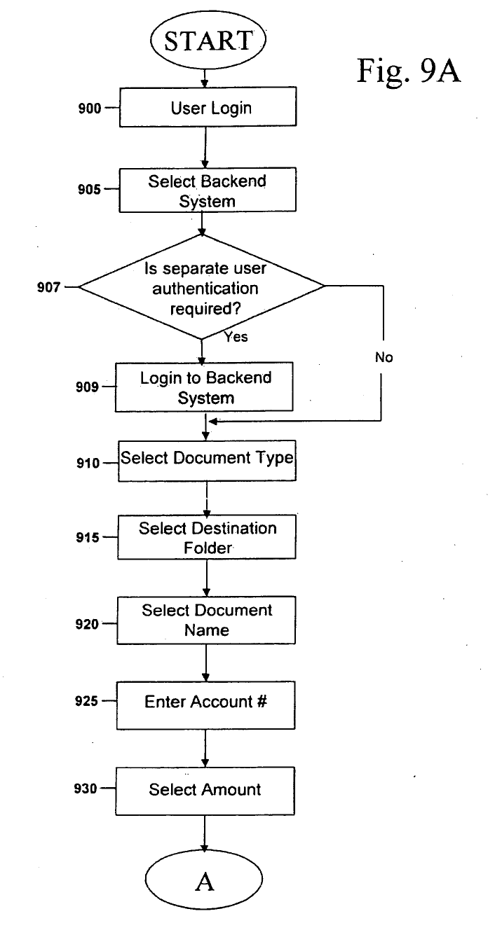

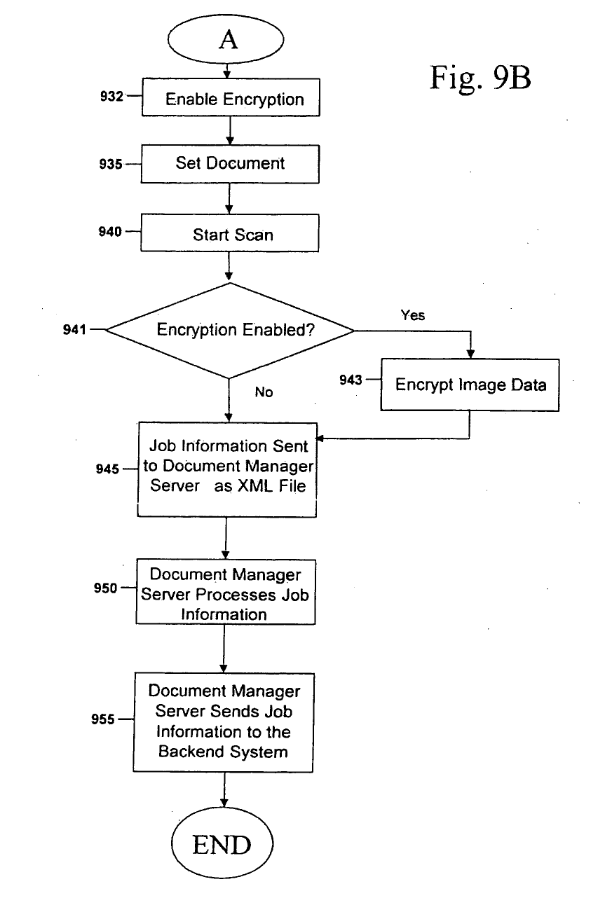

It should be noted that “Documentum” is portrayed as an example of a backend system, but any other backend application could also be handled similarly. Also, it should be noted that the user interface is able to be customized so as to contain more or less user options depending on how many backend applications are supported. The process of sending transmitting a scanned image to a backend system will be described in greater detail below in reference to FIGS. 9A-9B.

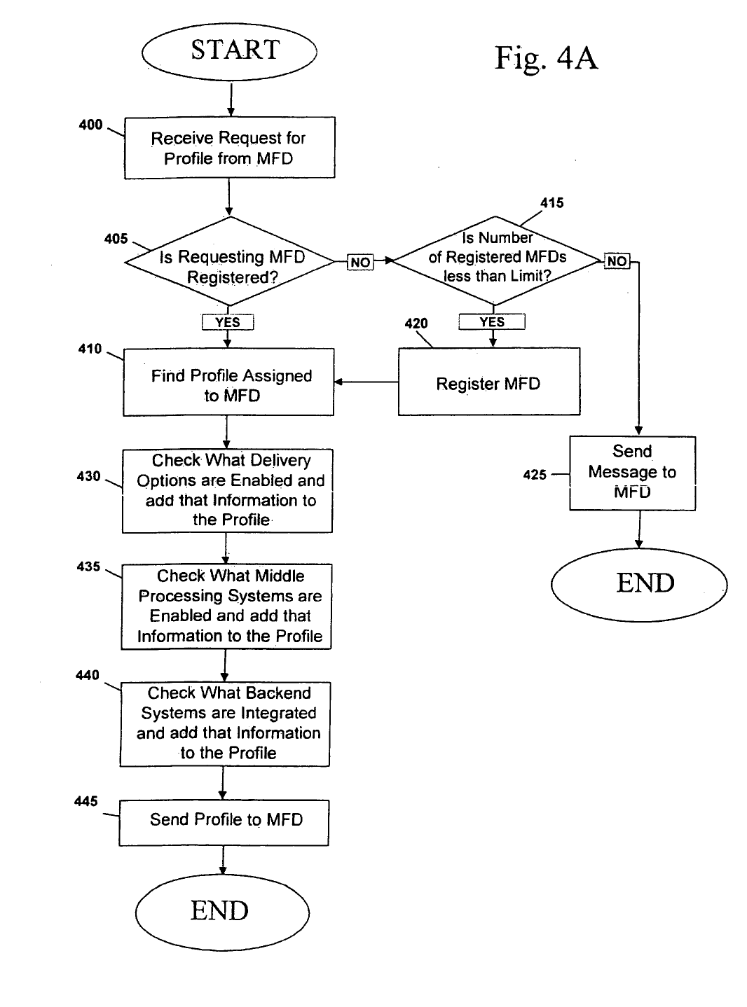

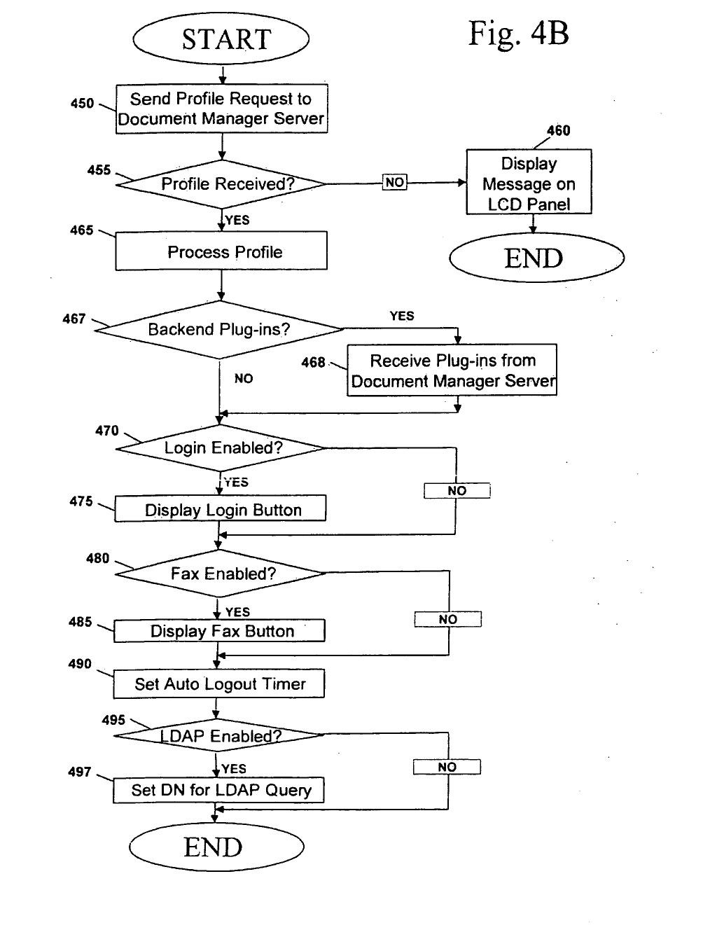

FIGS. 4A, 4B, 5, 6A-6B, 7A-7C, 9A-9B, 10A-10B and 11 are flowcharts depicting steps performed in authenticating a user and managing documents with the document manager server 40 according to various embodiments of the present invention.

The process shown in FIG. 4A illustrates a method performed by the document manager server 40. At step 400, the document manager server 40 receives a request for a profile from an image processing device or MFD. This request can include identification information identifying the requesting MFD. The identification information can include the serial number of the MFD and/or group identification for the MFD, or other identification information. A group identification can be for example an indication that the MFD belongs to a specific division with an organization, the group having a specific function, for example legal, accounting, marketing, or having a specific location, for example a floor, a building, a town, a state, a country, or having a specific security level, etc. Alternatively, the identification information can allow the document manager server 40 to look up further identification information, such as the division, group, or any other additional information, as specified above.

At step 405, the document manager server 40 inquires whether the MFD is registered, for example by looking up the identification information in a register that stores registered MFDs. If the MFD is registered, the document manager server 40 finds a profile assigned to the MFD at step 410. If the MFD is not registered, the document manager server 40 can compare at step 415 the number of registered MFDs with a predetermined number. This predetermined number can be for example the maximum number of devices licensed to use a particular application connected to the document manager server 40. This predetermined number (and information identifying its associated application) can be stored at the document manager server 40, and can be for example, 5, 25, 100, or any desired number, depending on the license agreement between the network application and the organization benefiting from the MFDs. License information can also be included in MFD profiles so that the MFD can change its user interface and functions accordingly. If the number of registered image processing devices is less than the predetermined number, the document manager server 40 can register the MFD at step 420 and find a profile assigned to the MFD at step 410. If the number of registered image processing devices is equal to the predetermined limit, the document manager server 40 can transmit a message to the MFD at step 425. The message can be an error message indicating that the services available to the document manager server are not available to the MFD because the maximum number of licensed MFDs is reached.

At step 430, the document manager server 40 determines the delivery options, e.g., fax server, e-mail server, which are available and adds this information to the profile. At step 435, the document manager server 40 determines which middle processing systems are available and adds this information to the profile. At step 440, the document manager server 40 ascertains the available backend systems and adds this information to the profile. This step optionally includes the attachment of a plug-in allowing the MFD to implement customized functions which allow it to operate with specific backend systems. At step 445, the document manager server 40 sends the profile and any plug-ins to the registered image processing device.

The document manager server 40 can repeat the above steps for several image processing devices. If the image processing devices belong to the same group within an organization, the document manager server 40 can transmit the same profile to each of the image processing devices. After the MFD has received its profile from the document manager server 40, the MFD can create an initial display user interface based on the various parameters provided in the profile and corresponding plug-in, as discussed next with FIG. 4B.

The process shown in FIG. 4B illustrates a method performed by an image processing device, e.g., an MFD, and can start, for example, when the image processing device is turned on. At step 450, the MFD sends a request for a profile to the document manager server 40. As noted above, this request can include identification, such as the serial number of the image processing device. At step 455, the MFD inquires whether the profile has been received from the document manager sever 40. If no profile has been received but instead an error message was received from the document manager server 40, the MFD displays a message at step 460. If the profile is received, the MFD processes the profile received at step 465. Then at step 467 the MFD determines if backend application requiring software plug-ins are enabled by the received profile. If software plug-ins are required, at step 468 the MFD transmits a message to the document managers server, and the document manager server transmits the required plug-in to the MFD. The plug-ins can be used by the MFD to assist in creating or customizing the user interfaces 3A-3B required to interface with available backend systems. It should be noted that the software plug-in may also be received in coordination, or simultaneously, with the profile information or at any other time. As part of this processing, the MFD can generate displays as a function of the profile parameters. For example, the MFD can generate specific menus or user interfaces based on the backend and middle processing systems identified in the profile. These user interfaces or menus may be generated from additional plug-in information corresponding to the backend and middle processing systems received at the MFD from the document manager server. This step of customizing the user interface based on received profile and plug-in information prevents the MFD from presenting a user interface, or menu option, to a user corresponding to a backend or middle processing system for which the user or MFD is not permitted access. At step 465, the MFD can also display graphics on its LCD based on default settings.

The parameters provided in the profile can correspond to functions that are optional for the MFD. Other functions are enabled by default within the MFD so that the MFD displays graphics corresponding to available functions automatically without inquiring whether the profile indicates that these default functions are enabled. Parameters corresponding to such default functions need not be part of the profile, if desired. In the example illustrated in FIG. 4B, the login, fax, and LDAP functions are optional so that the MFD inquires about their enablement by considering the parameters included in the profile. Also in this example, the e-mail function is enabled by default so that the MFD does not inquire about these functions. The present invention is not limited to this example and other combinations of optional/default functions are within the scope of the present invention.

At step 470, the MFD inquires whether its profile indicates that the login function is enabled. If the login function is enabled, the MFD displays a login button on its LCD panel at step 475. If the login function is not enabled, the MFD skips to step 480 where it inquires whether its profile indicates that the fax option is enabled. If the fax function is enabled, the MFD displays or enables a fax tab 315 on its LCD at step 485. If the fax option is not enabled, the MFD skips to step 490 where it sets an MFD auto logout timer based on a timer value provided in the profile.

At step 495, the MFD inquires whether its profile indicates that the LDAP option is enabled. If the LDAP option is enabled, at step 497 the MFD sets a base Distinguished Name (DN) for an LDAP query provided as part of the profile. The base DN provides a default field of search within which the LDAP search is performed unless a narrower field of search is requested. If the LDAP option is not enabled, the MFD skips the step 497. After performing these steps, the MFD has completed the steps used to gather and set appropriate information used to generate an initial user interface for the MFD, such as user interfaces illustrated in FIGS. 3A-3B. The present invention is not limited to the order of the steps shown in FIGS. 4A-B.

Using this initial user interface and other menus displayed by the MFD, the user of the MFD can access the various services available on the network through the document manager server 40. In general, the document manager server 40 receives job information from the image processing device; processes the job information at the document manager server 40; and transmits processed information to an application connected to the document manager server 40.

FIG. 5 illustrates a method of authenticating a user at an MFD according to one embodiment of the present invention. At step 505 the user inserts a smartcard to a smartcard reader. It should be noted that the smartcard reader may be located within the MFD 10-30 or it may be located externally to the MFD 10-30. In a case where the smartcard reader is located in a location not within the MFD 10-30, the MFD may perform the authentication process individually and communicate the result of the authentication with the MFD 10-30 upon either successful or unsuccessful authentication. Once the user enters the smartcard into the smartcard reader the user is prompted for a personal identification number (PIN) at step 510. The user may also be required to enter biometric information related to a physical attribute of the user. This may include reading the users fingerprint, scanning a user's retina, sensing a user's voice, or performing a facial recognition on the user. This entered biometric information may then be transformed into a mathematical representation which is compared to a mathematical model of the user's specified biometric information stored in the smartcard. Similarly, the PIN is then compared against a PIN stored by the smartcard by the MFD or the smartcard reader at step 515. Once the authentication step is complete and successful, the MFD accesses information stored in the smartcard which is specific to the user of the card. This information includes user identification, and a digital signature that is associated with the user information. The information retrieved from the smartcard is not limited to user ID or digital signature, but may also include other forms of user-specific information specific to the user. Moreover, a smartcard is not required and the invention may be implemented using alternative devices, memories, processors, and associated reading devices. For example, any desired device containing non-volatile memory can be used.

At step 525 the MFD determines if a digital signature retrieved from the smartcard is valid. If this digital signature is not valid, the MFD disables access for this user at step 520. Alternatively, if the digital signature is valid, at step 530 the document management server transmits the user ID and digital signature to the document manager server which then obtains user specific job processing instructions which are sent to the MFD. At step 535 the users sets the document on the MFD for processing. The user is then prompted at step 540 to enter a destination for the processed image, the destination may be an e-mail address, a folder in a document management system, or a network application connected to the document management server. It should also be noted that the destination and various other parameters may automatically be set by the user-specific job processing instructions sent from the document manager server at step 530.

At step 545, encryption is enabled for the processed image based on the user-specific information, or digital signature retrieved from the smartcard at step 525, if encryption is desired. This image may be encrypted using the digital signature retrieved from the smartcard or any other personal information or encryption information stored in relation to the user of the image processing device. At step 550 the user initiates scanning of the image, and at step 555 the MFD sends the encrypted scanned data to the document manager server. The document manager server then processes the image and at step 560 sends the encrypted scanned data to the intended destination. It should be noted that when the user enabled encryption, only the processed image may be created, or in the context of encrypting an e-mail, the entire e-mail may be encrypted.

FIGS. 6A and 6B illustrate a more detailed representation of the user authentication using a smartcard via the document management server. At step 605 the user inserts an electronic (or smartcard) to an electronic card (or smartcard) reader. The smartcard reader may be placed in near to or within the enclosure of the MFD. A biometric sensing device may also be included to collect biometric information input from a user. The smartcard reader and MFD can communicate either wired or wirelessly using various well known communication protocols and techniques. Once the user inserts the card into the card reader the user is then prompted to enter a PIN and/or biometric information at step 610.

At step 615 the smartcard reader or the MFD verifies that the PIN and/or biometric entered corresponds to the information stored on the smartcard. Specifically, when biometric authentication is enabled, a mathematical model representing the user's biometric parameter is stored in the electronic card. However, a mathematical model is not necessary and other manners of storing biometric information, such as by storing data or parameters, is possible. Once the user enters the biometric parameter at step 610, the biometric is transformed into a mathematical model which is then compared against the model stored in the smartcard at step 615. Again, as stated previously, this verification may take place at the smartcard reader or by the MFD, or by both depending on the system configuration.

Once authentication is successful, at step 620 the MFD reads a user's digital signature and user ID from the smartcard. At step 625 the MFD transmits the user ID and the digital signature retrieved at step 620 to the document manager server. The document manager server then transmits the user identification and digital signature to the directory server at step 630, which verifies the user's identification and additional information. At step 635 the directory server determines whether the user ID and digital signature are valid. If the user ID and digital signature are deemed to be invalid by the directory server at step 640, the directory server transmits a message to the MFD via the document manager server indicating that the additional information is not accepted on the network. At step 645, the MFD then disables user access based on a failed confirmation received from the document manager server. If however, the user ID and digital signature are verified and accepted by the directory server at step 650, the server sends an authentication confirmation to the document manager server.

In response to the confirmation, the document manager server requests a user's job processing instructions to the directory server at step 655. Then, at step 660 the directory server retrieves job processing instructions related to the user identification and additional information received from the document manager server and transmits the job processing instructions to the document manager server. At step 665 the document manager server transmits a user's job processing instructions to the MFD from the document manager server. At step 670 the MFD sets scan settings and job processing instructions based on the information received from the document manager server.

As stated above, it should be noted that the job processing instructions may relate to scan settings, file destinations or other parameters having an effect on the operation or functionality of the MFD. Examples of scan settings include resolution, density, scan mode, color/BW, paper size, file format, etc. The examples of file destinations may include any of the backend, middle wear, e-mail or facsimile network applications attached to the document manager server as discussed above.

FIGS. 7A-7C illustrate the process that takes place after the user is currently logged onto a network using the process described above. Specifically, FIG. 7A relates to a process for e-mailing a scanned image, FIG. 7B relates to a process for faxing a scanned image, and FIG. 7C relates to a method for sending processed image data to a backend application

At step 701 the user initiates a network login procedure, as depicted in FIGS. 6A-6B, by inserting a smartcard to the card reading device to initiate the login procedure. As previously stated, a smartcard is not required, but any memory device or device which can provide identification related information may be used. The user then enters user-specific authentication information in the form of a PIN or biometric feature at step 702, as described above in FIGS. 6A-6B. If the login is successful at step 703 the document manager server transmits profile, plug-in, and other necessary information in step 704 to the MFD. This information can be information from a profile stored in the document manager server, or may also be user-preference information received from the directory server after authentication. This information can be used to, among other things, customized interface as depicted in FIGS. 3A and 3B. Once the customized interface is displayed the user is able to select from a plurality of available options, backend systems, and device settings.

If the “E-mail” tab is pressed at step 705, then the process of sending an e-mail from the MFD is initiated. Once this option is selected, the user is presented, at step 706 with a user interface allowing the user to modify the list of intended recipients and subject of the transmitted e-mail at step 707. Once the user enters the appropriate information, the start key is enabled on the MFD 20 at step 708 and the user is able to initiate the scanning and subsequent e-mailing of the image. It should be noted that separate login is typically not required for access to the e-mail system since the user is already authenticated with the network. After completing the image processing and subsequent e-mail, the user is then prompted at step 709 with an option to perform further processing operations. If the user desires additional processing, the process returns to step 704. If the user selects indicated that they wish to perform no further processing at step 709, and then the image processing is terminated at step 710.

If the user selects the “Right Fax” tab at step 711, the process proceeds to step 712. At step 712, the profile, associated plug-in information, and other associated information received by the MFD from the document manager server is used by the MFD to determine if another authentication process is required for access to the facsimile application. If no authentication is required, then the “Right Fax” user interface 302 is displayed at step 714, as illustrated in FIG. 3A. At step 713, if user authentication is required for access to the fax application then the user may be prompted with the login user interface, or the user will be prompted to enter his of her smartcard and corresponding PIN or biometric to be authenticated with the facsimile server as depicted in the flowchart of FIG. 6A-6B. Once the user enters and submits the required authentication information, the facsimile server checks the user authentication against a database of registered users.

If the user is authenticated by the facsimile server, then the “Right Fax” user interface 302 is displayed and enabled at step 714. However, if user authentication is unsuccessful an error message is displayed to the user, for example in the system message area 360. Once the user is authenticated, at step 715, the user is able to enter a billing code, fax numbers, subject for the transmitted fax, and any additional optional information. Should the authentication take place in a manner similar to FIGS. 6A-6B, then the above-mentioned user-entered information may be included in the user-specific preferences retrieved in the server and transmitted to the MFD. Once this information is entered the user initiates the processing of the image by pressing a “Start” key, at step 708 and subsequent facsimile transmission of the image, as described below. The user is then prompted at step 709 with an option to perform further processing operations. If the user desires additional processing, the process returns to step 704. If the user selects no at step 709, then the image processing is terminated.

If the “Documentum” tab 320, or the tab representing any other backend application, is pressed at step 717, the software plug-in (or other information) received by the MFD from the document manager server 40 is used to determine at step 718, if a subsequent authentication process is required for the user to gain access to the backend system. Then, at step 719, the user may be prompted to use an authentication procedure similar to that described in relation to FIGS. 6A-6B by entering a smartcard and subsequently a PIN and/or biometric information. Alternatively, the “Documentum” login user interface 303 is displayed at step 719. In this authentication procedure, the user enters a “Username”, “Password”, and “Docbase” and the MFD transmits these parameters to the backend system for authentication. The backend system then compares the entered “Username” and “Password” against a database of these stored parameters and determines if the user is authorized to access the system. If, however, user authentication is unsuccessful an error message is displayed, for example in the system message area 360, and the user is denied access. Upon successful authentication, user-specific parameters may be retrieved from the authentication server and used at the MFD to automatically adjust settings and operations.

Once the user is granted access to the Documentum backend application, the image can be processed by the MFD and management, storage, retrieval and other file management operations can be performed on processed image using a displayed backend application interface at step 720. The user is also able to submit indexing information, metadata, and other customized processing information relating to the processing of the scanned image to the backend application interface at step 721. These parameters may also be included in the user-specific parameters downloaded from the authentication server, as discussed above.

Once the user enters the appropriate information, the start key is enabled at step 708 and the user can initiate the backend processing, as described below. The user is then prompted at step 709 with an option to perform further processing operations. If additional processing is requested the process returns to step 704. If termination of the processing is requested at step 709, then the image processing is terminated at step 710. The process described in relation to the Documentum application can be similarly performed, and the user interfaces similarly customized, for any other suitable backend application.

Additionally, the user of the MFD can request for the document manager server to route a document to an application connected to the document manager server, such as a fax server, an e-mail server, a file format conversion system, an OCR system, a document management system and a file storage system. In this case, the job information includes the document and the request for routing the document to an application.

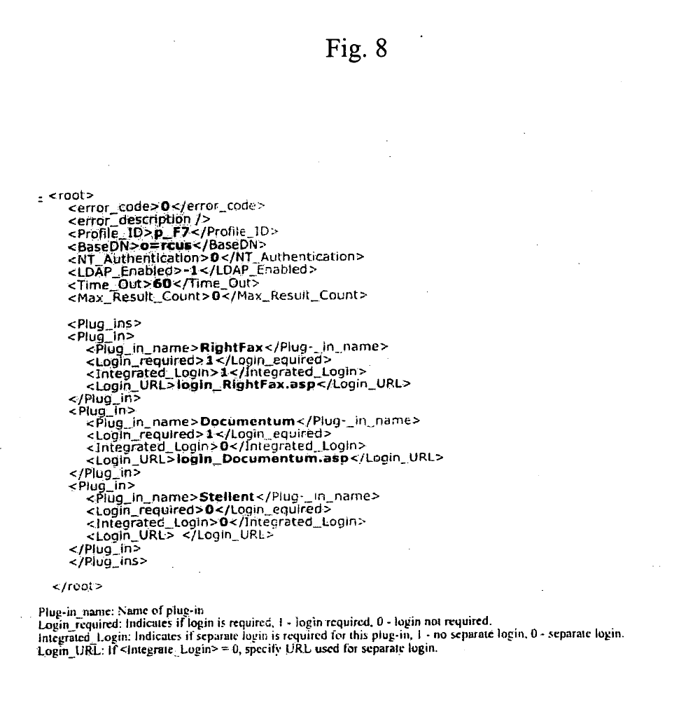

FIG. 8 is an example of code included in a software plug-in sent to an MFD, from the document manager server. Once the plug-in is received and processed by the MFD, the MFD can perform operations enabling a user to add specific processing instructions, index data or metadata to the image file before it is processed by the image processing device. The software plug-in is optionally not transmitted to the MFD until the MFD receives the backend parameter and determines the backend applications enabled by the MFD. The MFD then transmits a message to the document manager server indicating that a specific backend application is enabled. The document manager server responds by transmitting the software plug-in to the MDF allowing it to perform all necessary modifications to the MFD user interface and corresponding functionalities. The plug-in also allows the MFD to make a determination regarding the type of user authentication required for the user to gain access to a particular network application. Additionally, the software plug-in enables the MFD device to determine if the user is authenticated on another system, and whether that authentication procedure allows for the user to have access to a particular application. The user interface and of the MFD may also be customized based on the information and the plug-in to allow the user access to specific functionalities for a specific backend system. These capabilities will be described in greater detail below.

It should be further noted that the plug-in information may be transmitted from the authentication server to the MFD upon authentication of a user. As described in relation to FIGS. 6A-6B, when the user is authenticated using a smartcard and/or biometric information the authentication server determines whether user-specific parameters are stored, which correspond to the received user ID and digital signature. The software plug-in can be one of the pieces or user-specific authentication information transmitted from the server to the MFD.

FIGS. 9A-9B illustrate a flowchart depicting an exemplary method of sending a document to a backend system according to one embodiment. As mentioned above, the backend system can be for example a document management system or a file to scan system. At step 900, the MFD user can login to a network as discussed above in FIG. 6A-6B, and retrieve user-specific parameters for processing an image with the backend system. At step 905, the MFD user can select a backend system, such as a document management system. The MDF then examines the information received from the document manager server 40 (e.g. profile, plug-in, etc.) and determines at step 907 if the user is required to login to the backend system. If no user login is required then the process continues to step 910. If login is required, the user logs into the backend system at step 909 by either entering a username and password or as described above in FIG. 6A-6B. At step 910, the MFD user can select a document type using the MFD input device. For example, a menu of document types can be displayed so that the user can select one of the types using the touch sensitive user interface of the MFD. The document type can be used as index information when storing the document at the backend system. At step 915, the MFD user can select a destination folder where the document will be stored at the backend system. Again, this can be performed by selecting a folder from a list displayed on a user interface, or the destination folder can be entered using a keyboard. At step 920, the MFD user can enter the name of the document and/or other indexing information. At step 925, the user can enter an account number, which can be used by the document manager server 40 and/or by the backend system for management purposes, such as billing, accounting, activity monitoring. At step 930, the user can select an amount on an invoice when the document type is an invoice. At step 932 the user may decide to encrypt the processed image, or to insert the processed image into an encrypted communication, as discussed above. Other fields can be displayed on the MFD display in order to prompt the user to enter information (e.g., a numerical value) for different types of documents. It should be noted that any of the above-mentioned settings or preferences may be included in the user-specific preferences that are retrieved from the authentication server upon authentication of the user. Based on these settings the MFD scan settings, preferences, and general functionality may be automatically set or otherwise affected and based on the contents of the file.

At step 935, the document is set on the MFD scanning surface and at step 940, the document is scanned. At step 941 the MFD determines if the user has selected for the processed image to be encrypted. If encryption has been requested, the image is encrypted at step 943. Otherwise, the processed image is transmitted directly to the document manager server 40 at step 945, for example as an XML file. The job information can include the selected backend system, the scanned document, a request to route the document to the backend system, the document type, the destination folder, the document name, the account number, the amount, and whether the file is encrypted. At step 950, the document manager server 40 processes the job information received from the MFD. In one embodiment, the document manager server 40 sends the document to a middle processing system based on selected backend system. In other words, the document manager server 40 can recognize that the selected backend system requires a specific file format. The document manager server 40 automatically ensures that the document received from the MFD is in the proper format before sending it to the backend system. At step 955, the document manager server 40 transmits at least part of the processed job information (e.g., the document) to the backend system.

FIGS. 10A-10B show an example of a method for sending a fax using an MFD though the document manager server 40. At step 1000, the MFD user can login to a network as discussed above in FIGS. 6A-6B, and retrieve user-specific parameters for processing an image with the backend system. At step 1005, the MFD user can press a fax button, such as Fax button 315 shown in FIGS. 3A-3B. The MDF then examines the information received from the document manager server 40 (e.g. plug-in, profile, etc.) and determines at step 1007 if the user is required to login to the facsimile server. If no user login is required then the process continues to step 1010. If login is required, the user logs into the facsimile server at step 1009, as described above in FIGS. 6A-6B. Alternatively, the user may be authenticated using an interface similar to the interface depicted in FIG. 3A. If login is successful, at step 1010, the MFD user can enter a fax number using an MFD input device, such as a touch screen or a keypad. Alternatively, the fax number can be displayed and selected after accessing the global directory 60. At step 1015, the MFD user can enter fax notes that will be transmitted along with the faxed document. The user can enter the fax notes using the MFD input device. At steps 1020-1025, the user can enter billing codes if required in order to fax a document from the MFD. Whether or not the entry of a billing code is required can be determined by a profile parameter. The billing code corresponds to the entity who should be billed for the fax service. It should be noted that any of the above-mentioned settings or preferences may be included in the user-specific preferences that are retrieved from the authentication server upon authentication of the user. Based on these settings the MFD scan settings, preferences, and general functionality may be automatically set or affected and based on the contents of the file.

At step 1030, the document can be set on the MFD scanning surface. At step 1035, the scanning settings can be changed if desired, for example by accessing a scan setting menu displayed on the user interface. At step 1037 the user may decide to encrypt the processed image, or to insert the processed image into an encrypted communication, as discussed above. The document is then scanned at step 1040. A determination is then made regarding whether the user has requested that the fax be encrypted at step 1041. If the processed image is to be encrypted, then the MFD used the retrieved encryption data to encrypt the data at step 1042. The encrypted, or non-encrypted job information is sent to the document manager server 40, for example as an XML file, at step 1045. The job information in this case can include the scanned document, the request to route the document to the fax server, the billing codes, the scanning parameters, and the specified fax number. All which may be input manually, or entered automatically based on the user-specific preference information obtained from the authentication server. At step 1050, the document manager server 40 processes the job information received from the MFD. At step 1055, the document manager server 40 transmits at least part of the processed job information to the fax server in order to complete the fax transmission.

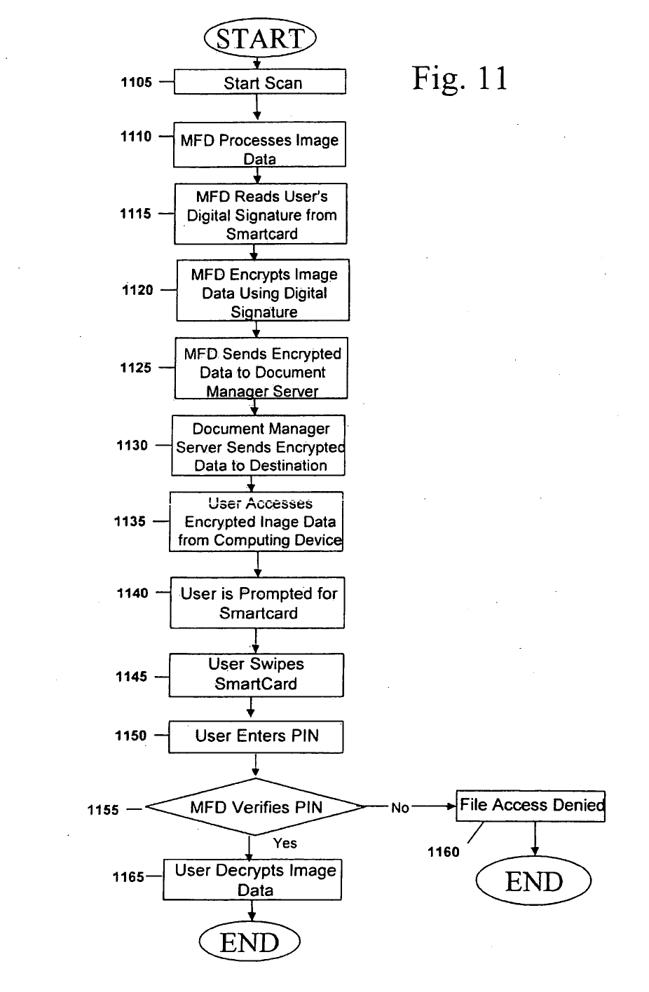

FIG. 11 depicts a method for secure image data transmission via e-mail following smartcard user authentication. Prior to the start of the process depicted in the flowchart, the user enters scanning and processing preferences similarly to the facsimile operation depicted in FIGS. 10A-10B. At step 1105 the user initiates processing of the image at the MFD. At step 1110 the MFD processes the image data, and at step 1115 the MFD retrieves the user's digital signature from the inserted smartcard. It should be noted that other encryption information can be retrieved and may also be retrieved from a location other than the smartcard. At step 1120 the MFD encrypts the image data by using the user's digital signature or encryption information retrieved from the smartcard at step 1115. Then, at step 1125 the MFD sends the encrypted data to the document manager server. At step 1130 the document manager server deposits the encrypted image data to a specified destination or network application by transmitting the processed image data through the document manager server to one or a plurality of network applications.

At step 1135 the user is able to access the encrypted image data using a processing device which is able to access one of the above-mentioned network. When the user requests access for an encrypted data at his or her processing device, the user must then be authenticated at that processing device in order to decrypt the encrypted image data. Thus, as depicted in FIG. 11, when the user access encrypted data at step 1135 from his or her personal computing device smartcard authentication occurs at step 1140. The user then inserts the smartcard into a smartcard reader at step 1145 and enters a PIN at step 1150 corresponding to the identification number stored on the smartcard. At step 1155 the MFD or smartcard reader verifies that the pin code is accurate and allows the user to decrypt and open the message at step 1165. However, if the entered PIN code is inaccurate or cannot be confirmed by the image processing device or smartcard reader file access is denied at step 1160.

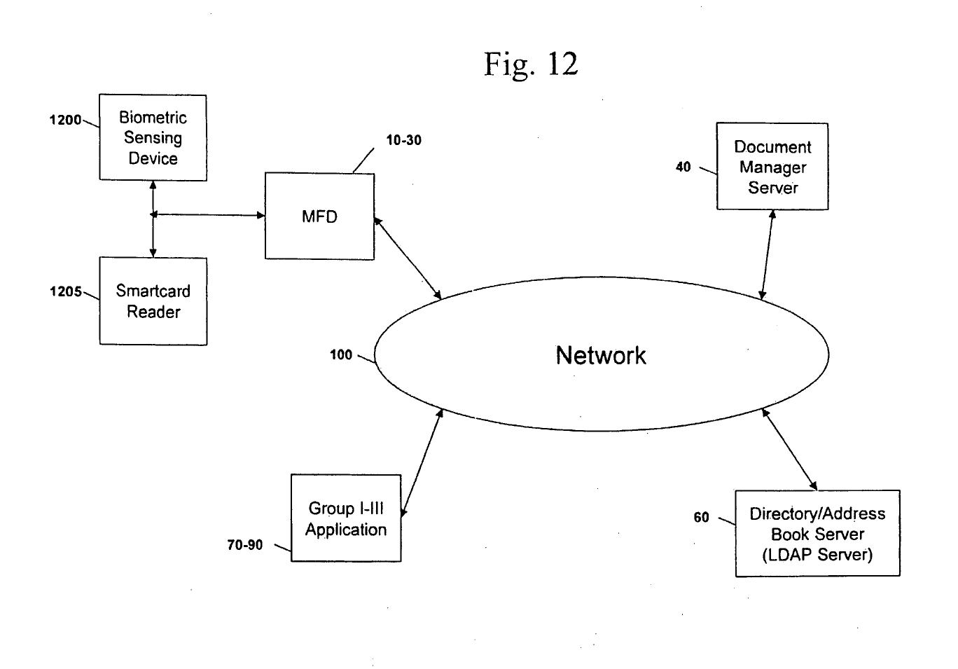

FIG. 12 illustrates an overview of the hardware used to implement the present invention. A smartcard reader 1205 is located in, at, or around the MFD 10-30. As stated previously, the smartcard reader 1205 may be located at a position outside of the MFD 10-30 and provide communications only to the MFD 10-30 when necessary. As previously stated, devices other than smartcard readers may be used, such as memory readers, proximity sensors or any other desired device. As stated above, the smartcard reader 1205, the biometric sensing device 1200, and the MFD 10-30 are in communication via a wireless or wired connection 100 using well know protocols and signal transmission techniques. It should be noted that the smartcard reader 1205 may also be implemented in conjunction with a biometrics device 1200 to provide multi-factor user authentication. The biometric detection device 1200 may include a mechanism for detecting user characteristics such as fingerprints, a retinal scan, voice recognition, facial recognition component, or any other desired characteristic. This entered biometric information is then compared against a biometric parameter stored on the smartcard itself. If the entered biometric information matches the biometric information stored in the smartcard then the user is successfully granted access to the system. The interaction between these devices and the roles of each device has been described in detail above. FIG. 12 also illustrates the document manager server 40, LDAP server 60 and network application server 70-90 which are described in greater detail below.

FIGS. 13-14 illustrate an example of the MFD 20, which includes a central processing unit (CPU) 1305, and various elements connected to the CPU 1305 by an internal bus 1310. The CPU 1305 services multiple tasks while monitoring the state of the MFD 20. The elements connected to the CPU 1305 include a read only memory (ROM) 1345, a random access memory (RAM) 1315, a hard disk drive (HDD) 1320, a floppy disk drive (FDD) 1350 capable of receiving a floppy disk 1355, a communication interface (I/F) 1330, and a modem unit 1360. In addition, a control panel 1375, a scanner unit 1370, a printer unit 1335, and an image processing device 1340 can be connected to the CPU 1305 by the bus 1310. Both the I/F 1330 and the modem unit 1360 are connected to a communication network 100.

In a preferred embodiment, the program code instructions for the MFD 20 are stored on the HDD 1320 via an IC card. Alternatively, the program code instructions can be stored on the floppy 1355 so that the program code instructions may be read by the FDD 1350, transferred to the RAM 1315 and executed by the CPU 1305 to carry out the instructions. These instructions can be the instructions to perform the MFD's functions described above. These instructions permit the MFD 20 to interact with the document manager server 40 via browser 25 and to control the control panel 1335 and the image processing units of the MFD 20.

During a start-up of the MFD 20, the program code instructions may be read by the CPU 1305, transferred to the RAM and executed by the CPU 1305. Alternatively, the program code instructions may be loaded to the ROM 1345. It is therefore understood that in the present invention any of the floppy disk 1355, the HHD 1330, the RAM 1315, and the ROM 1345 correspond to a computer readable storage medium capable of storing program code instructions. Other devices and medium that can store the instructions according to the present invention include for example magnetic disks, optical disks including DVDs, magneto-optical disks such as MOS, and semiconductor memory cards such as PC cards, compact flash cards, smart media, memory sticks, etc.

In a preferred embodiment, the control panel 1375 includes a user interface that displays information allowing the user of the MFD 20 to interact with the document manager server 40, such as the user interfaces 302-303 illustrated in FIGS. 3A-3B. The display screen can be a LCD, a plasma display device, or a cathode ray tube CRT display. The display screen does not have to be integral with, or embedded in, the control panel 1375, but may simply be coupled to the control panel 1375 by either a wire or a wireless connection. The control panel 1375 may include keys for inputting information or requesting various operations. Alternatively, the control panel 1375 and the display screen may be operated by a keyboard, a mouse, a remote control, touching the display screen, voice recognition, or eye-movement tracking, or a combination thereof.

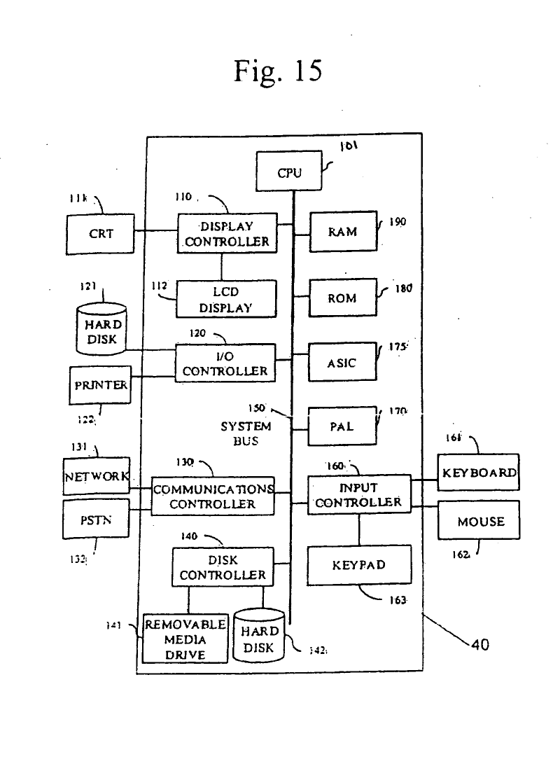

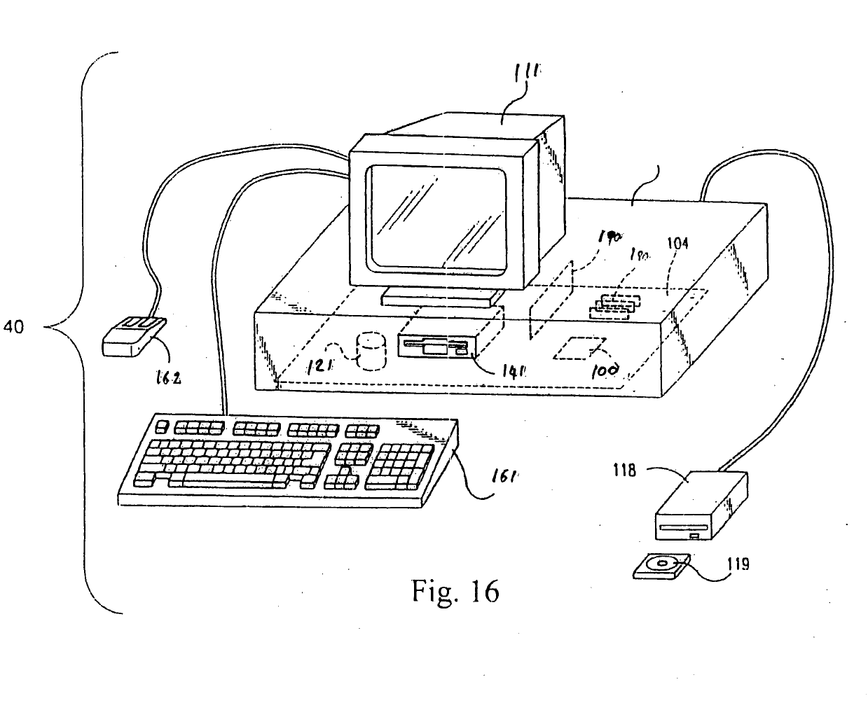

FIG. 15 is a block diagram of a server 40, 50, 60 according to one embodiment of the present invention. FIG. 16 is a schematic representation of the server. The server 40, 50, 60 includes a central processing unit 101 (CPU) that communicates with a number of other devices by way of a system bus 150. The server 40, 50, 60 includes a random access memory (RAM) 190 that hosts temporary storage values used in implementing the authenticating, routing and managing functions of documents.

A conventional personal computer or computer workstation with sufficient memory and processing capability may also be configured to operate as the server 40. The central processing unit 101 is configured for high volume data transmission and performing a significant number of mathematical calculations in processing communications and database searches. A Pentium 4 microprocessor such as the 3.4 GHz Pentium 4 manufactured by Intel Inc. or Advanced Micro Devices (AMD) Athlon 64 3.5 GHz processor may be used for the CPU 101. Other suitable processors and multiple processors or workstations may be used as well.

The ROM 180 is preferably included in a semiconductor form although other read-only memory forms including optical media may be used to host application software and temporary results. The ROM 180 connects to the system bus 150 for use by the CPU 101. The ROM 180 includes computer readable instructions that, when executed by the CPU 101, can perform the different authenticating, routing and managing functions discussed above associated with scanned documents from MFDs. An input controller 160 connects to the system bus 150 and provides an interface with peripheral equipment, including a keyboard 161 and a pointing device such as a mouse 162. The input controller 160 may include different ports such as a mouse port in the form of a PS2 port or, for example, a universal serial bus (USB) port. The keyboard port for the input controller 160 is in the form of a mini-DIN port although other connectors may be used as well. The input controller 160 provides sound card connections so that external jacks on the sound card allow users to attach microphone speakers or an external sound source. The input controller 160 also may include serial ports or parallel ports as well.

A disk controller 140 is in the form of an IDE controller and connects via ribbon cables to a floppy disk drive 141 as well as a hard disk drive 142, a CD-ROM drive 118 and a compact disk 119. In addition, a PCI expansion slot is provided on the disk controller 140 or mother board that hosts the CPU 101. An enhanced graphic port expansion slot is provided and provides 3-D graphics with fast access to the main memory. The hard disk 121 may also include a CD-ROM that may be readable as well as writeable. A communication controller 130 provides a connection, for example by way of an Ethernet connection to a network 131, which can be the network 101. In one embodiment, the network 131 and the connection to the communication controller 130 are made by way of a plurality of connections including a cable-modem connection, DSL connection, dial-up modem connection, and the like that connect to the communication controller 130.

An input/output controller 120 also provides connections to external components such as an external hard disk 121, printer 122, which can be MFD 10-3, for example, by way of an RS 232 port, a SCSI bus, an Ethernet or other network connection which supports any desired network protocol such as, but not limited to TCP/IP, IPX, IPX/SPX, or NetBEUI.

A display controller 110 interconnects the system bus 150 to a display device, such as a cathode ray tube (CRT) 111. While a CRT is shown, a variety of other display devices may be used such as an LCD, or plasma display device.

The mechanisms and processes set forth in the present description may be implemented using a conventional general purpose microprocessor(s) programmed according to the teachings of the present specification, as will be appreciated to those skilled in the relevant arts. Appropriate software coding can readily be prepared by skilled programmers based on the teachings of the present disclosure, as will also be apparent to those skilled in the software art. In particular, the computer program product for authenticating, routing, and managing documents according to the present invention can be written in a number of computer languages including but not limited to C, C⁺⁺, Fortran, and Basic, as would be recognized by those of ordinary skill in the art. The invention may also be implemented by the preparation of applications specific integrated circuits or by interconnecting an appropriate network of conventional component circuits, as will be readily apparent to those skilled in the art. Thus, the invention is not limited to the implementations shown in the specification, and ordinary programming and methods of generating interfaces which are alternative to web interfaces, http, etc. may be used.

The present invention thus also includes a computer-based product that may be hosted on a storage medium and include instructions that can be used to program a computer to perform a process in accordance with the present invention. This storage medium can include, but is not limited to, any type of disk including floppy disks, optical disks, CD-ROM, magneto-optical disks, ROMs, RAMs, EPROMs, EEPROMs, Flash Memory, Magnetic or Optical Cards, or any type of media suitable for storing electronic instructions.

Advantageously, the present invention can be incorporated with the system and method for managing documents disclosed in applications Ser. No. 09/795,438, filed Mar. 1, 2001; U.S. application Ser. No. 10/243,645, filed Sep. 16, 2002; and U.S. application Ser. No. 10/294,607, filed Nov. 15, 2002; the entire content of each are hereby incorporated by reference.

Obviously, numerous additional modifications and variations of the present invention are possible in light of the above teachings. It is therefore to be understood that within the scope of the appended claims the present invention may be practiced otherwise than as specifically described herein.

1. A method for authenticating a user of an image processing system, comprising:
entering first user identification data at an image processing device;
sensing, at the image processing device, second user identification data from a physical object;
transmitting the first and second user identification data to a first server;
authenticating the user using the first and second user identification data;
transmitting information corresponding to the user from the first server to the image processing device.

2. The method of claim 1, wherein the step of entering first user identification data comprises:
entering a personal identification number

3. The method of claim 1, wherein the step of entering first user identification data comprises:
entering biometric information corresponding to the user, by presenting physical characteristics of the user to a device configured to collect biometric information.

4. The method of claim 3, wherein the step of entering first user identification data comprises:
entering physical characteristics of the user including at least one of the user's facial characteristics, a fingerprint, retinal information and vocal information.

5. The method of claim 3, further comprising the steps of:
comparing the entered biometric information to a plurality of stored biometric information corresponding to authorized users; and
determining if entered biometric information matches one of the plurality of biometric information corresponding to authorized users.

6. The method according to claim 3, wherein the step of sensing the second user identification data comprises:
sensing the second user identification data from a device having a memory.

7. The method of claim 1, wherein the step of sensing the second user identification data comprises:
sensing the second user identification data from a device having a memory.

8. The method of claim 6, wherein the step of sensing the second user identification data comprises:
sensing the second user identification data from a memory which is a card.

9. The method of claim 1, wherein the step of sensing second user identification data, comprises:
sensing a digital signature corresponding to the user identified by the user identification data.

10. The method of claim 1, wherein the step of sensing second user identification data comprises:
sensing encryption information corresponding to the user identification data.

11. The method of claim 1, wherein the step of authenticating the user using the first and second identification data comprises:
comparing the first and second identification data against stored user identification data; and
determining if the first and second identification data match the stored user identification data.

12. The method of claim 1, wherein the step of transmitting information corresponding to the user from the first server to the image processing device comprises:
transmitting information related to a scan setting of the image processing device.

13. The method of claim 12, wherein the step of transmitting information corresponding to the user from the first server to the image processing device comprises:
transmitting information related to resolution, density, scan mode, color, paper size and file format settings for a scanned image.

14. The method of claim 1, wherein the step of transmitting information corresponding to the user from the first server to the image processing device comprises:
transmitting information indicating the identity of a network application corresponding to a destination for processed image data.

15. The method of claim 1, wherein the step of transmitting information corresponding to the user from the first server to the image processing device comprises:
transmitting an executable file configured to be executed by the image processing device.

16. The method of claim 1, further comprising the step of:
changing image processing settings of the image processing device based on the information corresponding to the user received from the first server.

17. The method of claim 1, further comprising the step of:
changing a user interface of the image processing device based on the information corresponding to the user received from the first server.

18. The method of claim 1, further comprising the step of:
changing a functionality of the image processing device based on the information corresponding to the user received from the first server.

19. The method of claim 1, wherein the step of transmitting the first and second user identification data to a first server comprises:
transmitting the first and second user identification data to a second server; and
transmitting the first and second user identification data from the second server to the first server.

20. The method of claim 19, further comprising the step of:
transmitting a confirmation from the first server to the second server indicating that a user authentication was successful at the first server.

21. The method of claim 20, further comprising the step of:
transmitting a request from the second server to the first server for the information corresponding to the user.

22. The method of claim 21, further comprising the step of:
transmitting the information corresponding to the user from the first server to the second server in response to the request; and
transmitting the information corresponding to the user from the second server to the image processing device.

23. The method of claim 1, further comprising the steps of:
sensing, at the image processing device, encryption information;
encrypting image data processed by the image processing device;
transmitting the encrypted image data from the image processing device to a network application

24. The method of claim 23, further comprising the step of:
transmitting the encrypted image data from the image processing device to the second server.

25. The method of claim 24, further comprising the step of:
transmitting the encrypted image data from the second server to a network application connected to the second server.

26. The method of claim 23, further comprising the step of:
retrieving the encrypted image data from the network application and decrypting the image data.

27. A system for authenticating a user of an image processing system, comprising:
means for entering first user identification data at an image processing device;
means for sensing, at the image processing device, second user identification data from a physical object;
means for transmitting the first and second user identification data to a first server;
means for authenticating the user using the first and second user identification data;
means for transmitting information corresponding to the user from the first server to the image processing device.

28. The system of claim 27, wherein:
the means for entering first user identification data collects first user identification data which includes a personal identification number.

29. The system of claim 27, wherein:
the means for entering first user identification data collects first user identification data which includes biometric information corresponding to the user.

30. The system of claim 29, wherein:
the means for entering first user identification data collects physical characteristics of the user including at least one of the user's facial characteristics, a fingerprint, retinal information and vocal information.

31. The system of claim 29, further comprising:
means for comparing the biometric information corresponding to the user to a plurality of stored biometric information corresponding to authorized users; and
means for determining if the biometric information corresponding to the user matches one of the plurality of biometric information corresponding to authorized users.

32. The system according to claim 29, wherein:
the means for sensing the second user identification data senses the second user identification data from a device having a memory.

33. The system of claim 27, wherein:
the means for sensing the second user identification data senses the second user identification data from a device having a memory.

34. The system of claim 32, wherein:
the means for sensing the second user identification data senses the second user identification data from a memory which is a card.

35. The system of claim 27, wherein:
the means for sensing the second user identification data senses the second user identification data which includes a digital signature corresponding to the user identified by the user identification data.

36. The system of claim 27, wherein:
the means for sensing the second user identification data senses the second user identification data which includes encryption information corresponding to the user identification data.

37. The system of claim 27, wherein:
the means for authenticating the user compares the first and second identification data against stored user identification data, and determines if the first and second identification data match the stored user identification data.

38. The system of claim 27, wherein:
the means for transmitting information corresponding to the user transmits information related to a scan setting of the image processing device.

39. The system of claim 36, wherein:
the means for transmitting information corresponding to the user transmits information related to resolution, density, scan mode, color, paper size and file format settings for a scanned image.

40. The system of claim 27, wherein:
the means for transmitting information corresponding to the user transmits information indicating the identity of a network application corresponding to a destination for processed image data.

41. The system of claim 27, wherein:
the means for transmitting information corresponding to the user transmits an executable file configured to be executed by the image processing device.

42. The system of claim 27, further comprising:
means for changing image processing settings of the image processing device using the information corresponding to the user received from the first server.

43. The system of claim 27, further comprising:
means for changing a user interface of the image processing device using the information corresponding to the user received from the first server.

44. The system of claim 27, further comprising:
means for changing a functionality of the image processing device using the information corresponding to the user received from the first server.

45. The system of claim 27, further comprising:
the means for transmitting the first and second user identification data transmits the first and second user identification data to a second server, and
means for transmitting the first and second user identification data from the second server to the first server.

46. The system of claim 45, further comprising:
means for transmitting a confirmation from the first server to the second server indicating that a user authentication was successful at the first server.

47. The system of claim 46, further comprising:
means for transmitting a request from the second server to the first server for the information corresponding to the user.

48. The system of claim 47, further comprising:
means for transmitting the information corresponding to the user from the first server to the second server in response to the request; and
means for transmitting the information corresponding to the user from the second server to the image processing device.

49. The system of claim 27, further comprising:
means for sensing encryption information at the image processing device;
means for encrypting image data processed by the image processing device;
means for transmitting the encrypted image data from the image processing device to a network application.

50. The system of claim 49, further comprising:
means for transmitting the encrypted image data from the image processing device to the second server.

51. The system of claim 49, further comprising:
means for transmitting the encrypted image data from the second server to a network application connected to the second server.

52. The system of claim 47, further comprising:
means for retrieving the encrypted image data from the network application and decrypting the image data.

53. A system for authenticating a user of an image processing system, comprising:
an input connected to an image processing device and configured to receive first user identification data;
a sensor connected to the image processing device and configured to sense second user identification data from a physical object;
an interface of the image processing device configured to transmit the first and second user identification data to a first server;
a module of the first server configured to authenticate the user using the first and second user identification data;
an interface of the first server configured to transmit information corresponding to the user from the first server to the image processing device.

54. The system of claim 53, wherein:
the input is configured to receive the first user identification information which includes a personal identification number.

55. The system of claim 53, wherein the input configured to receive first user identification data comprises:
a device configured to collect biometric information corresponding to the user, by collecting physical characteristics of the user.

56. The system of claim 55, wherein:
the device configured to collect biometric information is configured to collect information representative of physical characteristics of the user including at least one of the user's facial characteristics, a fingerprint, retinal information and vocal information.

57. The system of claim 55, wherein the device configured to collect biometric information comprises:
a processor configured to compare the collected biometric information to a plurality of stored biometric information corresponding to authorized users and determine if the collected biometric information matches one of the plurality of biometric information corresponding to authorized users.

58. The system according to claim 55, wherein:
the sensor is configured to sense the second user identification data from a device having a memory.

59. The system of claim 53, wherein:
the sensor is configured to sense the second user identification data from a device having a memory.

60. The system of claim 58, wherein:
the sensor is configured to sense the second user identification data from a device having a memory which is a card.

61. The system of claim 53, wherein:
the sensor is configured to sense the second user identification data which includes a digital signature corresponding to the user identified by the user identification data.

62. The system of claim 53, wherein:
the sensor is configured to sense the second user identification data which includes encryption information corresponding to the user identification data.

63. The system of claim 53, wherein the first server comprises:
another module configured to compare the first and second identification data against stored user identification data and determine if the first and second identification data match the stored user identification data.

64. The system of claim 53, wherein:
the interface of the first server is configured to transmit information corresponding to the user which includes information related to a scan setting of the image processing device.

65. The system of claim 62, wherein:
the interface of the first server is configured to transmit information corresponding to the user which includes information related to resolution, density, scan mode, color, paper size and file format settings for a scanned image.

66. The system of claim 53, wherein:
the interface of the first server is configured to transmit information corresponding to the user which includes information indicating the identity of a network application corresponding to a destination for processed image data.

67. The system of claim 53, wherein:
the interface of the first server is configured to transmit information corresponding to the user which includes an executable file configured to be executed by the image processing device.

68. The system of claim 53, wherein the image processing device comprises:
a processor configured to change image processing settings of the image processing device based on the information corresponding to the user received from the first server.

69. The system of claim 53, wherein the image processing device comprises:
a processor configured to change a user interface of the image processing device based on the information corresponding to the user received from the first server.

70. The system of claim 53, wherein the image processing device comprises:
a processor configured to change a functionality of the image processing device based on the information corresponding to the user received from the first server.

71. The system of claim 53, further comprising:
the interface of the image processing device configured to transmit the first and second user identification data to a second server; and
an interface of the second server configured to transmit the first and second user identification data from the second server to the first server.

72. The system of claim 71, wherein:
the interface of the first server is configured to transmit a confirmation from the first server to the second server indicating that a user authentication was successful at the first server.

73. The system of claim 72, wherein:
the interface of the second server is configured to transmit a request from the second server to the first server for the information corresponding to the user.

74. The system of claim 73, wherein:
the interface of the first server is configured to transmit the information corresponding to the user from the first server to the second server in response to the request; and
the interface of the second server is configured to transmit the information corresponding to the user from the second server to the image processing device.

75. The system of claim 53, further comprising:
the sensor connected to the image processing device configured to sense encryption information;
a processor of the image processing device configured to encrypt image data processed by the image processing device using the encryption information;
the interface of the image processing device configured to transmit the encrypted image data from the image processing device to a network application

76. The system of claim 75, wherein:
the interface of the image processing device is configured to transmit the encrypted image data from the image processing device to the second server.

77. The system of claim 76, wherein:
the interface of the second server is configured to transmit the encrypted image data from the second server to a network application connected to the second server.

78. The system of claim 75, further comprising:
a processing device configured to retrieve the encrypted image data from the network application and decrypt the image data.
